(19) United States
(12) Patent Application Publication
(10) Pub. No.: US 2016/0090218 A1
(43) Pub. Date: Mar. 31, 2016

(54) POLYMERIC MATERIAL

(71) Applicant: Berry Plastics Corporation, Evansville, IN (US)

(72) Inventors: David Dezhou Sun, Evansville, IN (US); Jonathan Eickhoff, Evansville, IN (US); Jeffrey P. Meunier, Newburgh, IN (US); Jared B. Waterman, Evansville, IN (US)

(21) Appl. No.: 14/862,552

(22) Filed: Sep. 23, 2015

Related U.S. Application Data
(60) Provisional application No. 62/055,088, filed on Sep. 25, 2014.
(60) Provisional application No. 62/057,715, filed on Sep. 30, 2014.
(60) Provisional application No. 62/208,008, filed on Aug. 21, 2015.

(51) Int. Cl. B65D 43/02; F16L 59/02; B65D 43/06; C08J 9/06

(52) U.S. Cl. CPC B65D 43/0212; C08J 9/06; F16L 59/028; B65D 43/065

(57) ABSTRACT

A drink cup lid is manufactured from an extrudate. The extrudate is a polymeric material.

### PRIORITY CLAIM

This application claims priority under 35 U.S.C. §119(e) to U.S. Provisional Application Ser. No. 62/055,088, filed Sep. 25, 2014, 62/057,715 filed Sep. 30, 2014, and 62/208,008 filed Aug. 21, 2015, each of which is expressly incorporated by reference herein.

### BACKGROUND

The present disclosure relates to polymeric materials that can be formed to produce a closure for a container, and in particular, polymeric materials that insulate. More particularly, the present disclosure relates to polymer-based formulations that can be formed to produce an insulated non-aromatic polymeric material.

### SUMMARY

According to the present disclosure, a drink cup lid may be manufactured from an extrudate produced in a flat-die or annular-die extrusion process. The extrudate is a polymeric material.

In illustrative embodiments, the extrudate is produced from a formulation comprising a polymeric material. The extrudate is then formed in a thermoforming process to establish a closure for a container. The closure has a density in a range of about 0.5 g/cm³ to about 0.85 g/cm³. At those densities, the closure has a thermal conductivity in a range of about 0.1 W/(m*K) to about 0.2 W/(m*K). At least a portion of the closure has a surface roughness in a range of about 5 nm to about 365 nm, and/or at least a portion of the closure has a surface roughness in a range of about 1 μm to about 250 μm.

In illustrative embodiments, the closure includes a lid spout and a center panel closing a mouth formed in the container. The lid spout may have a different thermal conductivity, density, and/or surface roughness as compared to the center panel of the closure.

In illustrative embodiments, the formulation comprises a regrind polymeric material and a chemical blowing agent. In illustrative embodiments, the formulation comprises a high crystalline polymeric material and the chemical blowing agent. In illustrative embodiments, the polymeric material includes the regrind polymeric material, the high crystalline polymeric material, and the chemical blowing agent.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective view of a lid in accordance with a first embodiment of the present disclosure and a cup before the lid is mounted on the cup and showing that the lid includes a central closure surrounded by a brim mount that is formed to include four seal rings in mating engagement with a brim of the cup and with an interior surface of an upper interior portion of the cup side wall just below the brim;

FIG. 2 is an enlarged top plan view of the lid of FIG. 1;

FIG. 3 is a sectional view taken along line 3-3 of FIG. 2 showing the cross-sectional shape of the brim mount of the lid;

FIG. 4 is a perspective and diagrammatic view of a portion of a flat-die extrusion system used to produce the lid of FIGS. 1-3;

FIG. 5 is another partial perspective view of a portion of a flat-die extrusion system in accordance with the present disclosure;

FIG. 6 is a front elevation view of a portion of an annular die used to produce the lid of FIGS. 1-3;

FIG. 7 is a sectional view taken along line 7-7 of FIG. 6;

FIG. 8A is a diagrammatic view of a female (negative) mold system showing the female mold system in a closed position with a hot sheet of insulative non-aromatic polymeric material located in a mold area prior to molding;

FIG. 8B is a view similar to FIG. 8A showing the hot sheet after molding;

FIG. 8C is a diagrammatic view of a male (positive) mold system showing a hot sheet of insulative non-aromatic polymeric material located in a mold area prior to molding;

FIG. 8D is a view similar to FIG. 8C showing the hot sheet after molding;

FIG. 8E is a diagrammatic view of a match-metal thermoforming system showing the match-metal thermoforming system in an open position with a hot sheet of insulative non-aromatic polymeric material located in a mold area prior to molding;

FIG. 8F is a view similar to FIG. 8E showing the hot sheet after molding;

FIG. 9 is a diagrammatic view of a large-scale thermoforming system used to produce the lid of FIGS. 1-3;

FIG. 10 is a photograph showing a test lid made from an insulative non-aromatic polymeric material and a test piece cut from a drink spout included in the test lid to test density and thermal conductivity of the material in the area of the drink spout;

FIG. 11 is a graph showing thermal conductivity (W/(m*K)) on the y-axis versus density (g/cm³) on the x-axis for samples made from various formulations of insulative non-aromatic polymeric material in accordance with the present disclosure, various formulations of insulative non-aromatic polymeric materials, and solid non-aromatic polymeric materials;

FIG. 12 is a diagrammatic view of an exemplary process for performing atomic force microscopy (AFM) to measure surface roughness;

FIG. 13 is a diagrammatic view of an exemplary process for performing non-contact optical surface roughness measurements (e.g., non-contact optical profilometry, digital microscope in topography mode);

FIG. 14 is profilometry scan showing the measurement results obtained by imaging a 1.6 mm×1.6 mm area of a drink lid via non-contact profilometry;

FIG. 15 is profilometry scan showing the measurement results obtained by imaging a 0.8 mm×0.8 mm area of a drink lid via non-contact profilometry;

FIG. 16 is profilometry scan showing the measurement results obtained by imaging a 400 μm×400 μm area via non-contact optical profilometry;

FIG. 17 is a three-dimensional plot-height image showing the measurement results obtained by imaging a 20 μm×20 μm area of a drink lid via AFM;

FIG. 18 is a three-dimensional plot showing the measurement results obtained by imaging the surface of a black plastic part with a HIROX® digital microscope in topography mode;

FIG. 19 is a three-dimensional plot showing the measurement results obtained by imaging the surface of a white plastic part with a HIROX® digital microscope in topography mode;

FIG. 20 is a three-dimensional machine screen capture and corresponding 1D profile scan showing the measurement results obtained by imaging the surface of a black plastic part with a HIROX® digital microscope in topography mode; and

FIG. 21 is a three-dimensional machine screen capture and corresponding 1D profile scan showing the measurement results obtained by imaging the surface of a white plastic part with a HIROX® digital microscope in topography mode.

### DETAILED DESCRIPTION

According to the present disclosure, a liquid container comprises a cup and a lid adapted to mate with a brim of the cup. The lid is formed to include a liquid-discharge outlet communicating with an interior region formed in the cup when the lid is mounted on the brim of the cup so that consumers can drink a liquid stored in the cup through the liquid-discharge outlet when the lid is mounted on the brim of the cup. The lid is made from an insulative non-aromatic polymeric material configured to provide means for controlling movement of heat between the liquid stored in the interior region of the cup and a user's lips during discharge of the liquid through the liquid-discharge outlet so that comfort of the user is maximized.

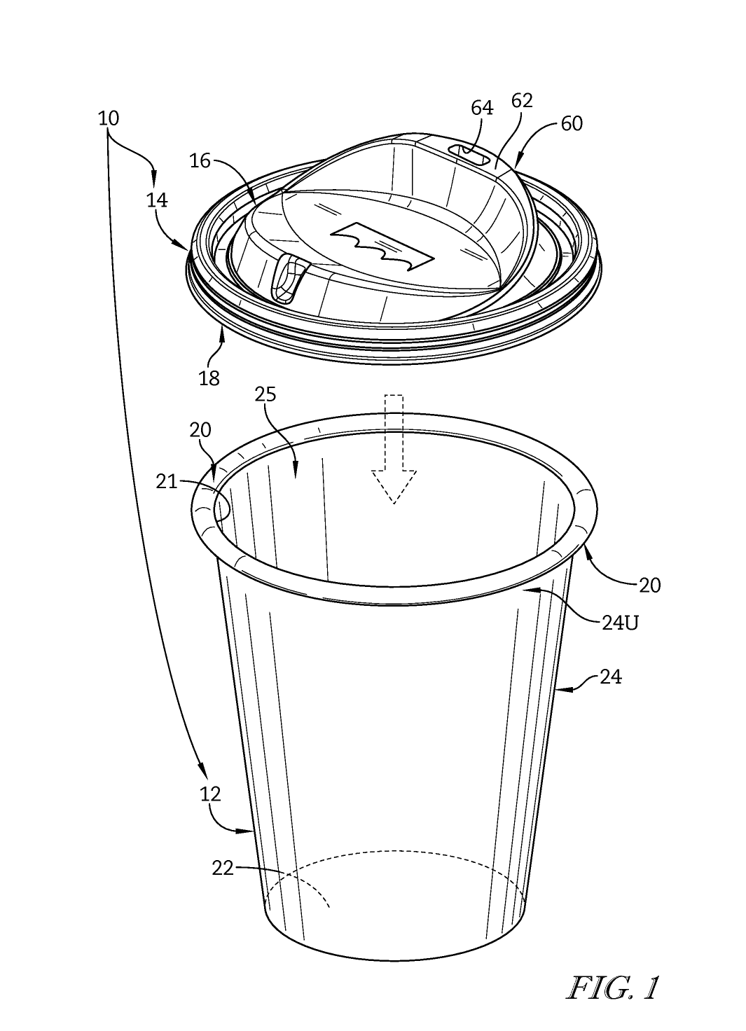

A liquid container 10 includes a cup 12 and a lid 14 as shown, for example, in FIG. 1. Lid 14 includes a central closure 16 and brim mount 18 coupled to central closure 16 and configured to be mounted on a brim 20 included in cup 12 to arrange central closure 16 to close a cup mouth 21 opening into an interior region 25 formed in cup 12 as suggested in FIG. 1.

As shown in FIG. 1, cup 12 includes brim 20, a floor 22, and a side wall 24 extending upwardly from floor 22 to brim 20. It is within the scope of this disclosure to make cup 12 out of any suitable plastics, paper, or other material(s).

In an illustrative embodiment, a consumer can drink a hot liquid stored in cup 12 while lid 14 remains mounted on the brim 20 of cup 12 through the liquid-discharge outlet 64 formed in lid 14. In an illustrative embodiment, central closure 16 of lid 14 includes a drink spout 60 formed to include liquid-discharge outlet 64. Drink spout 60 is adapted to be received in the mouth of a consumer desiring to drink liquid stored in cup 12. In illustrated embodiments, central closure 16 includes an upstanding drink spout 60 formed to include liquid-discharge outlet 64 in a top wall 62 thereof.

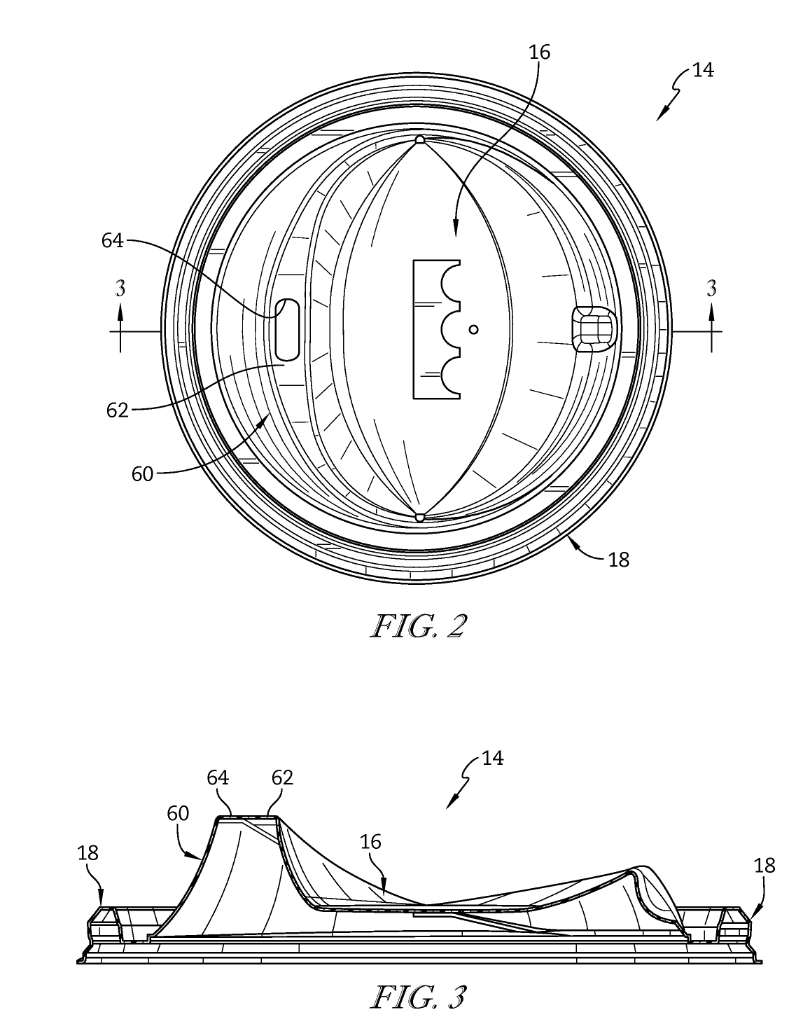

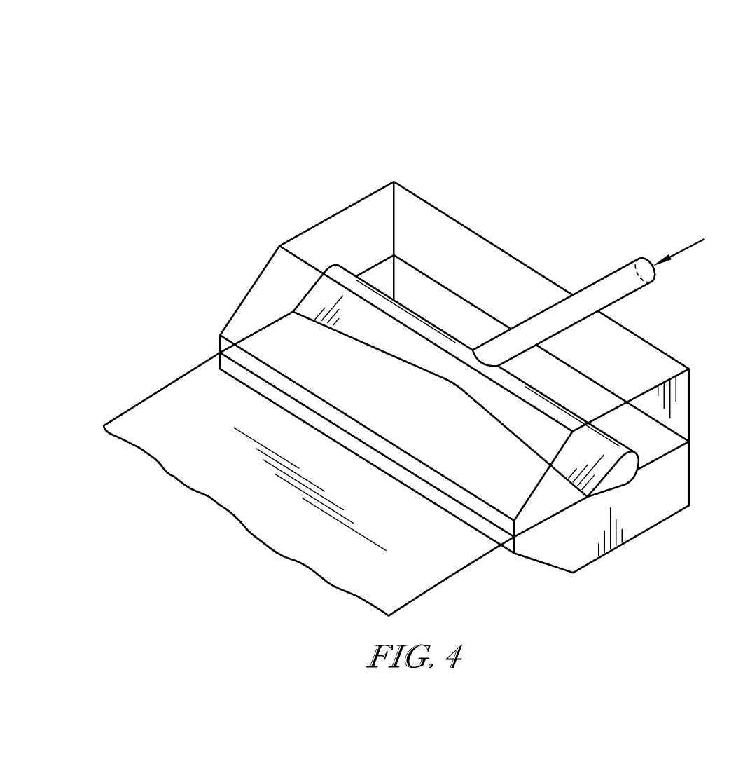

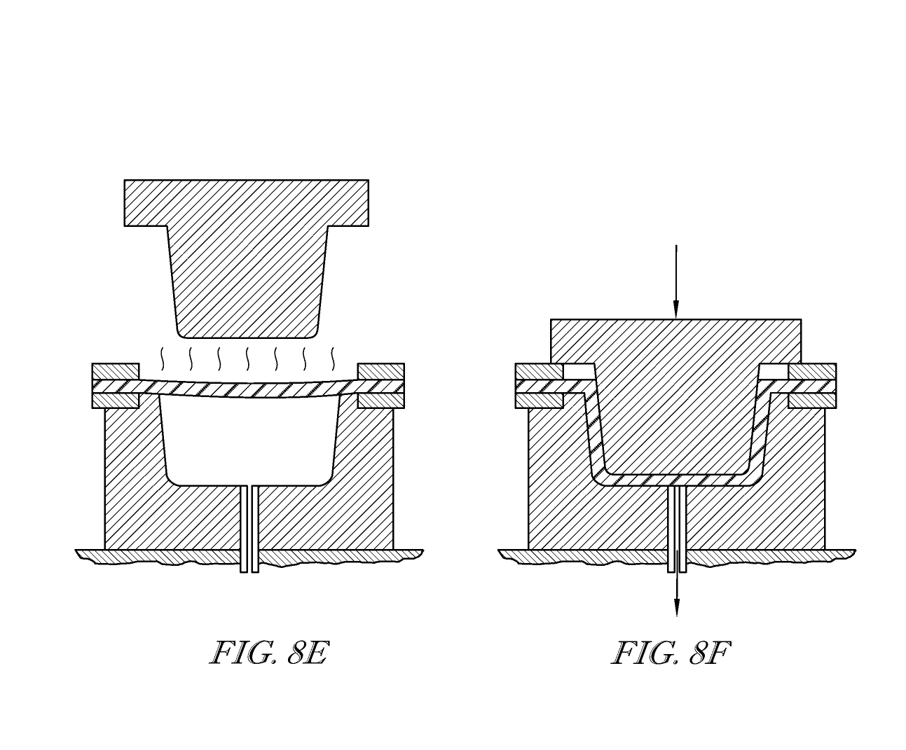

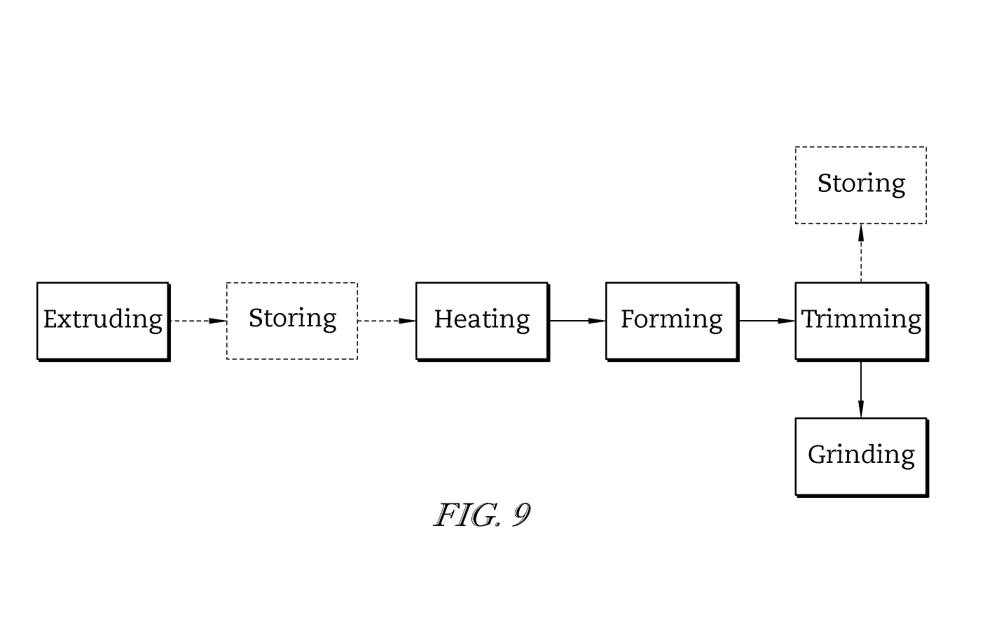

In illustrative embodiments, a sheet of insulative non-aromatic polymeric material is made from a formulation during an extrusion process in accordance with the present disclosure. The sheet of insulative non-aromatic polymeric material is thermoformed to produce a lid as suggested in FIGS. 1-9. Thermoforming may be performed using a female (negative) mold with or without application vacuum, a male (positive) mold with or without application of vacuum, or match metal thermoforming. Match-metal thermoforming uses both the female (negative) mold and the male (positive) mold to form the sheet of insulative non-aromatic polymeric material.

In a thermoforming process, a sheet of insulative non-aromatic polymeric material is heated to provide a hot sheet of insulative non-aromatic polymeric material. The hot sheet then indexes into a mold area. A mold then moves from an open position to a closed position. Vacuum is applied to a mold cavity formed in the mold to remove any trapped air in the mold cavity. Plug assist or form air engages the hot sheet to help the hot sheet form onto the mold in the mold cavity to form a formed sheet including multiple insulative lids coupled to a carrier sheet. The plug then retracts, when present. The mold opens and the formed sheet is stripped from the mold cavity via a stripper plate and/or expulsion air. The formed sheet is then indexed out of the mold area. The formed sheet is then trimmed to form individual insulative lids separated from the carrier sheet.

During the extrusion process, the sheet is expanded using a chemical blowing agent (also known as a chemical foaming agent) with or without a physical blowing agent such as nitrogen (N₂) or carbon dioxide (CO₂) gas included in the formulation. In one example, the formulation includes high crystalline polypropylene resin. A high crystalline polypropylene resin is a polypropylene resin that has about a 98.5% isotacticity index and about 1.5% wt xylene solubles. Isotactic index may be determined according to ISO 9113, titled Determination of Isotactic Index, which is hereby incorporated by reference herein in its entirety. Xylene solubles may be determined according to ISO 16152, titled Determination of Xylene-Soluable matter in Polypropylene, which is hereby incorporated by reference herein in its entirety. Xylene soluables may be determined according to ASTM D5492-10, titled Standard Test Method for Determination of Xylene Solubles in Propylene Plastics, which is hereby incorporated by reference herein in its entirety. In extruding the polypropylene resin, lower heat provides higher foaming of the material.

In one example, the formulation comprises a linear low density polyethylene, a low density polyethylene, an ethylene copolymer, a polypropylene copolymer, a polypropylene, a polystyrene, a nylon, a polycarbonate, a polyester, a copolyester, a poly phenylene sulfide, a poly phenylene oxide, a random copolymer, a block copolymer, an impact copolymer, a homopolymer polypropylene, a polylactic acid, a polyethylene terephthalate, a crystallizable polyethylene terephthalate, a styrene acrylonitrile, a poly methyl methacrylate, a polyvinyl chloride, an acrylonitrile butadiene styrene, a polyacrylonitrile, a polyamide, or a combination thereof.

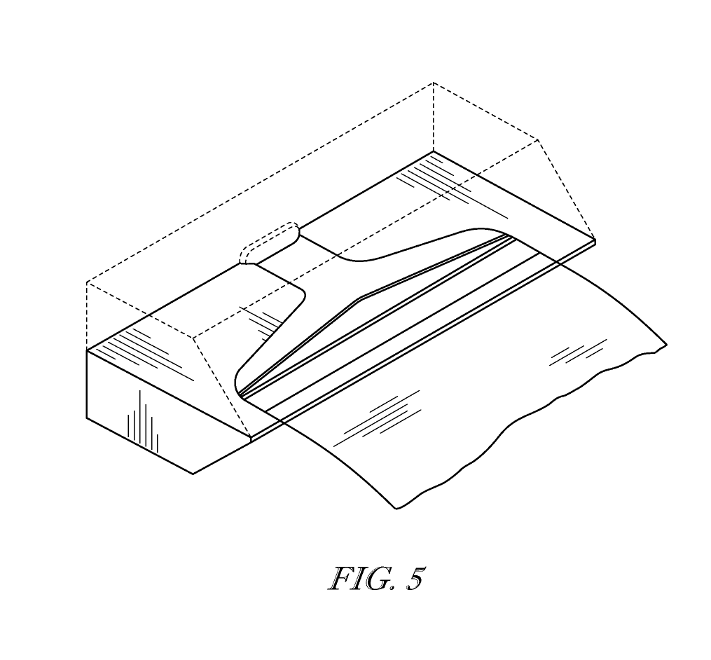

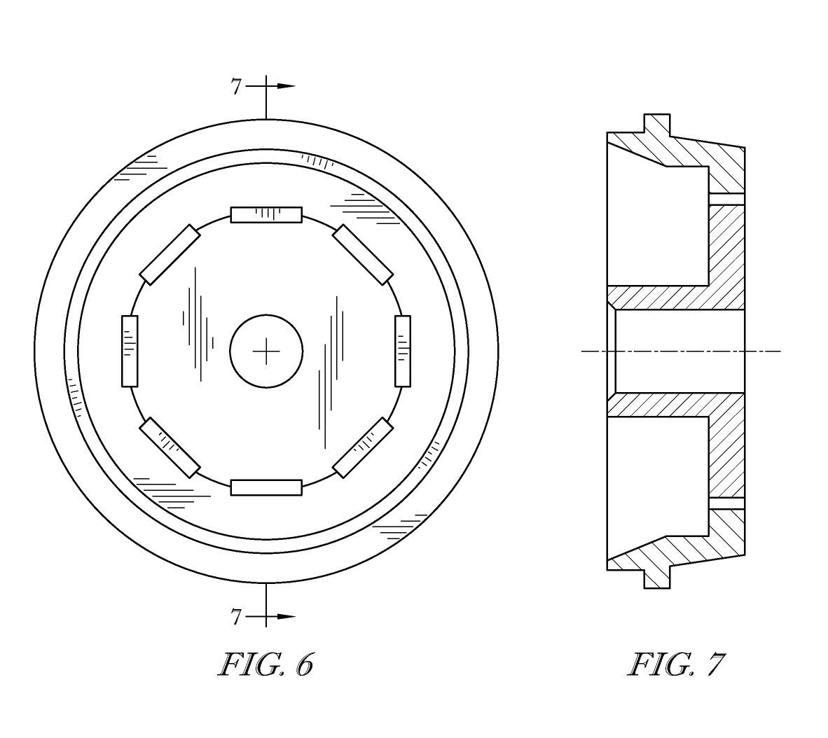

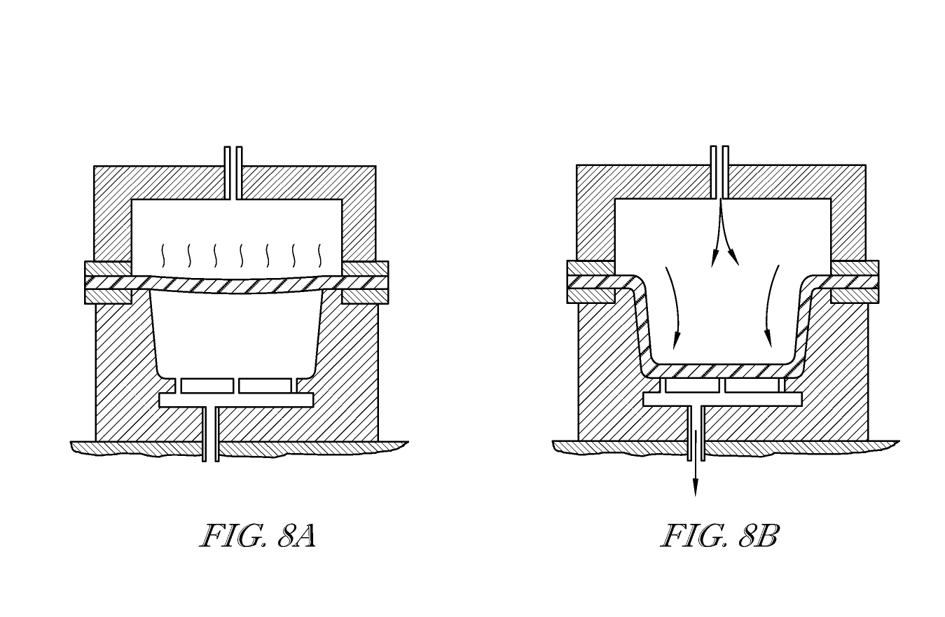

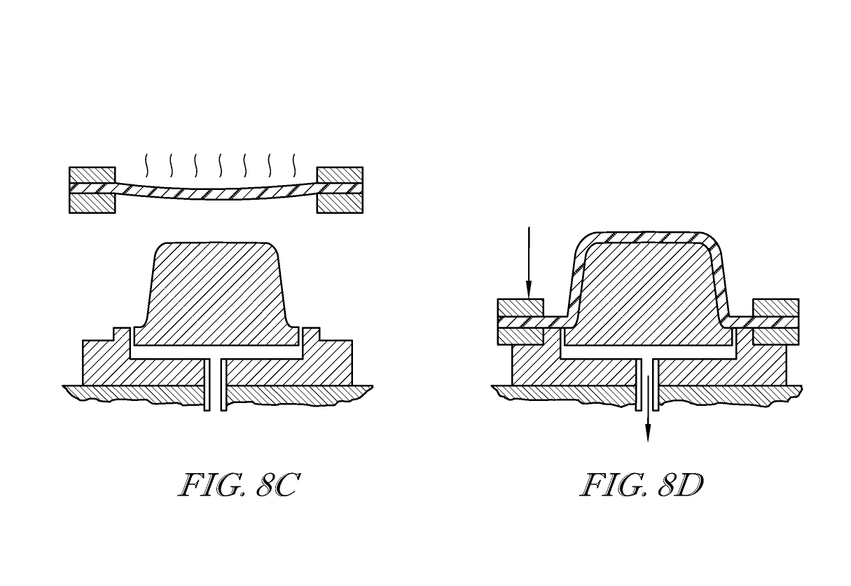

The formulation may be extruded via annular die extrusion or flat die extrusion. In one example, the formulation is extruded via a flat-die extrusion system as suggested in FIGS. 4 and 5. In another example, the formulation is extruded via an annular-die extrusion system as suggested in FIGS. 6 and 7. The annular extrudate is then slit to produce the sheet.

In another example, a formulation includes a regrind polymeric material. The regrind polymeric material may be up to 100%, by weight, of the polymeric material included in the formulation. In another example, the formulation includes the regrind polymeric material and one or more other polymeric resins.

The regrind polymeric material may be ground-up previously-produced insulative non-aromatic polymeric material made using a formulation in accordance with the present disclosure. The regrind polymeric material may be a ground-up previously-produced insulative cellular non-aromatic polymeric material made in accordance with the formulations disclosed in U.S. application Ser. No. 13/491,327 filed on 7 Jun. 2012 and entitled POLYMERIC MATERIAL FOR AN INSULATED CONTAINER, U.S. application Ser. No. 14/063,252 filed on 25 Oct. 2013 and entitled POLYMERIC MATERIAL FOR AN INSULATED CONTAINER, U.S. App. No. 61/866,741 filed on 16 Aug. 2013 and entitled POLYMERIC MATERIAL FOR AN INSULATED CONTAINER, U.S. App. No. 61/949,126 filed on 6 Mar. 2014 and entitled POLYMERIC MATERIAL FOR AN INSULATED CONTAINER, U.S. application Ser. No. 14/462,073 filed on 18 Aug. 2014 and entitled POLYMERIC MATERIAL FOR AN INSULATED CONTAINER, the disclosure of each of which is expressly incorporated by reference herein. The regrind polymeric material may be a combination of the ground-up previously-produced insulative non-aromatic polymeric material and the ground-up previously-produced insulative cellular non-aromatic polymeric material.

The regrind polymeric material may include an insulative cellular non-aromatic polymeric material formed to produce an insulative cup or other product. In an illustrative embodiment, the regrind polypropylene may be a low-density insulative cellular non-aromatic polymeric material used to produce an insulative cup or other product. In an embodiment, the base resin used to form the previously-produced insulative cellular non-aromatic polymeric material may be polypropylene or polyethylene.

Illustrative lids for drink cups are produced from sheets of insulative non-aromatic polymeric material formed using a formulation comprising regrind polymeric material. The amount of regrind polymeric material may be one of several different values or fall within one of several different ranges. It is within the scope of the present disclosure to select an amount of regrind polymeric material to be one of the following values: about 0%, 5%, 10%, 20%, 25%, 30%, 40%, 50%, 60%, 70%, 75%, 80%, 90%, and 100% of the total formulation by weight percentage. It is within the scope of the present disclosure for the amount of regrind polymeric material in the formulation to fall within one of many different ranges. In a first set of ranges, the range of regrind polymeric material is one of the following ranges: about 40% to 100%, 50% to 100%, 60% to 100%, 70% to 100%, 80% to 100%, and 90% to 100% of the total formulation by weight percentage. In a second set of ranges, the range of regrind polymeric material is one of the following ranges: about 10% to 90%, 10% to 80%, 10% to 70%, 10% to 60%, 10% to 50%, 10% to 40%, 10% to 30%, and 10% to 20% of the total formulation by weight percentage. In a third set of ranges, the range of regrind material is one of the following ranges: about 20% to 80%, 30% to 70%, 40% to 60%, and 45% to 55% of the total formulation by weight percentage.

Regrind polymeric material is formed from either insulative cellular non-aromatic polymeric material or insulative non-aromatic polymeric material. During extrusion of either insulative cellular non-aromatic polymeric material or insulative non-aromatic polymeric material, the melt strength of the polymers used to form the insulative cellular non-aromatic polymeric material or insulative non-aromatic polymeric material is believed to have been consumed. As a result, grinding the insulative cellular non-aromatic polymeric material or insulative non-aromatic polymeric material to form regrind polymeric material is believed to provide materials lacking sufficient melt strength for forming an insulative non-aromatic polymeric material in accordance with the present disclosure. Thus, the ability to use regrind polymeric material to provide acceptable insulative non-aromatic polymeric material is unexpected.

The spout included in the lid has a density. Density may vary according to the formulation of insulative non-aromatic polymeric material used and the process used to form the lid. Density of the spout may be one of several different values or fall within one of several different ranges. It is within the scope of the present disclosure for the density to be one of the following values: about 0.68 g/cm³, 0.69 g/cm³, 0.7 g/cm³, 0.71 g/cm³, 0.72 g/cm³, 0.73 g/cm³, 0.74 g/cm³, 0.75 g/cm³, 0.76 g/cm³, 0.77 g/cm³, 0.78 g/cm³, 0.79 g/cm³, 0.8 g/cm³, 0.81 g/cm³, 0.82 g/cm³, 0.83 g/cm³, 0.84 g/cm³, and 0.85 g/cm³. It is within the scope of the present disclosure for the density to fall within one of many different ranges. In a first set of ranges, the range of density of the spout is one of the following ranges: about 0.5 g/cm³ to 0.9 g/cm³, 0.5 g/cm³ to 0.85 g/cm³, 0.5 g/cm³ to 0.8 g/cm³, 0.5 g/cm³ to 0.75 g/cm³, 0.5 g/cm³ to 0.7 g/cm³, 0.5 g/cm³ to 0.65 g/cm³, and 0.5 g/cm³ to 0.6 g/cm³. In a second set of ranges, the range of density of the spout is one of the following ranges: about 0.6 g/cm³ to 0.9 g/cm³, 0.6 g/cm³ to 0.85 g/cm³, 0.6 g/cm³ to 0.8 g/cm³, 0.6 g/cm³ to 0.75 g/cm³, 0.6 g/cm³ to 0.7 g/cm³, and 0.6 g/cm³ to 0.65 g/cm³. In a third set of ranges, the range of density of the spout is one of the following ranges: about 0.65 g/cm³ to 0.9 g/cm³, 0.65 g/cm³ to 0.85 g/cm³, 0.65 g/cm³ to 0.8 g/cm³, 0.65 g/cm³ to 0.75 g/cm³, and 0.65 g/cm³ to 0.7 g/cm³. In a fourth set of ranges, the range of density of the spout is one of the following ranges: about 0.7 g/cm³ to 0.9 g/cm³, 0.7 g/cm³ to 0.85 g/cm³, 0.7 g/cm³ to 0.8 g/cm³, and 0.75 g/cm³ to 0.8 g/cm³. In a further embodiment, the spout density is in a range of 0.350 g/cm³ to 0.850 g/cm³.

While neither desiring to be bound by any particular theory nor intending to limit in any measure the scope of the appended claims or their equivalents, it is presently believed that the thermal conductivity of insulative non-aromatic polymeric material is related—at least in part—to the density of the insulative non-aromatic polymeric material. The thermal conductivity may be one of several different values or fall within one of several different ranges. It is within the scope of the present disclosure for the thermal conductivity to be one of the following values: about 0.13 W/(m*K), 0.14 W/(m*K), 0.15 W/(m*K), 0.16 W/(m*K), and 0.17 W/(m*K). It is within the scope of the present disclosure for the thermal conductivity to fall within one of many different ranges. In a first set of ranges, the range of thermal conductivity is one of the following ranges: about 0.13 W/(m*K) to 0.17 W/(m*K), 0.13 W/(m*K) to 0.16 W/(m*K), 0.13 W/(m*K) to 0.15 W/(m*K), and 0.13 W/(m*K) to 0.14 W/(m*K). In a second set of ranges, the range of thermal conductivity is one of the following ranges: about 0.14 W/(m*K) to 0.17 W/(m*K), 0.14 W/(m*K) to 0.16 W/(m*K), and 0.14 W/(m*K) to 0.15 W/(m*K). In third set of ranges, the range of thermal conductivity is one of the following ranges: about 0.15 W/(m*K) to 0.17 W/(m*K) and 0.16 W/(m*K) to 0.17 W/(m*K).

In an example, a lid may have a thermal conductivity of about 0.05 W/(m*K) to 0.3 W/(m*K) and a density of about 0.5 g/cm³ to 0.85 g/cm³. In an example, a lid may have a thermal conductivity of about 0.1 W/(m*K) to 0.2 W/(m*K) and a density of about 0.5 g/cm³ to 0.85 g/cm³. In an example, a lid may have a thermal conductivity of about 0.13 W/(m*K) to 0.17 W/(m*K) and a density of about 0.5 g/cm³ to 0.85 g/cm³. In an example, a lid may have a thermal conductivity of about 0.15 W/(m*K) and a density of about 0.7 g/cm³. In an example, a lid may have a combined thermal conductivity and density as previously described herein. In an example, a lid may have any combination of thermal conductivity and density as previously described herein.

While neither desiring to be bound by any particular theory nor intending to limit in any measure the scope of the appended claims or their equivalents, it is believed that the thermal conductivity of insulative non-aromatic polymeric material is further related—at least in part—to the surface roughness of the insulative non-aromatic polymeric material. Surface roughness may vary according to the formulation of insulative non-aromatic polymeric material used, the process used to form the lid, the type of characterization technique used to quantify the surface roughness (e.g., atomic force microscopy, non-contact optical profilometry, digital microscopy in topography mode, and/or the like), and/or the size of the sample area subjected to measurement.

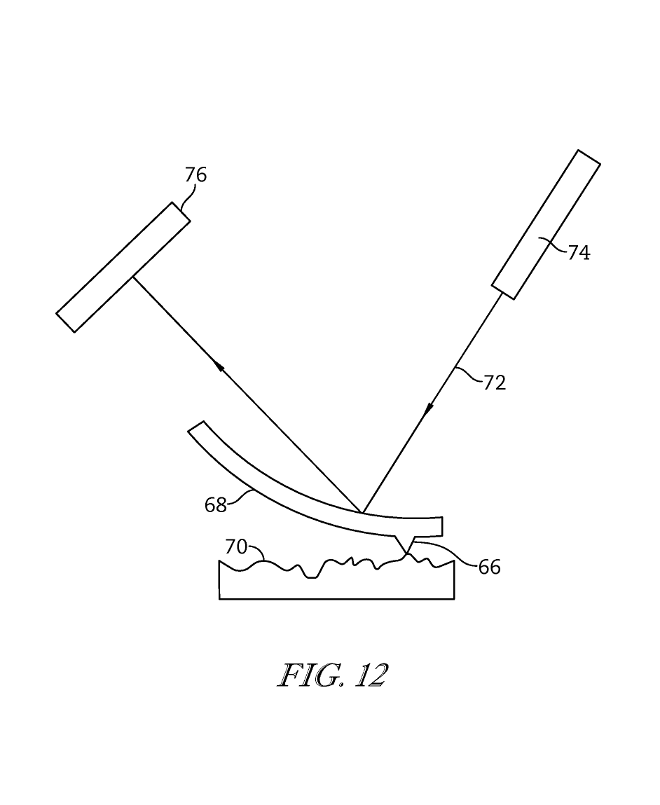

Atomic force microscopy (AFM) refers to a technique for measuring the roughness of a surface at high resolution. AFM microscopy may be used to measure surface roughness on the order of fractions of a nanometer. As shown in simplified schematic form in FIG. 12, an atomic force microscope works by moving a stylus tip 66 of a cantilever 68 across the surface 70 of a sample. Forces between the stylus tip 66 and the surface 70 may cause a deflection of the cantilever 68 in accordance with Hooke's law. The amount of this deflection may be measured in various ways. For example, as shown in FIG. 12, a laser beam 72 from a laser 74 may be reflected off the cantilever 68 onto a photo-detector 76. As the cantilever 68 is displaced via interaction with the surface 70, the reflection of the laser beam 72 onto the surface of the photo-detector 76 is likewise displaced, and the amount of this displacement may be quantified. AFM is a high-resolution technique and roughness on the order of from less than about 1 nm up to about 100 nm may be characterized via AFM. In one example, the sample size imaged via AFM is about 20 μm×20 μm.

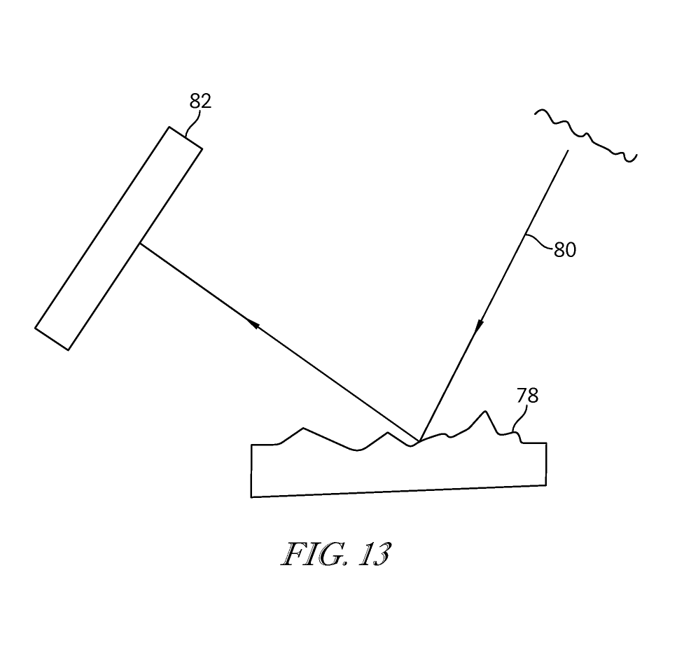

Non-contact optical profilometry refers to a technique for measuring surface roughness using a profilometer. In contrast to AFM in which a stylus is physically moved across a surface in order to measure its roughness, optical profilometry utilizes an optical probe to measure height variations on the surface without physically touching the surface with a mechanical part. As shown in simplified schematic form in FIG. 13, the surface 78 of a sample may be scanned with an optical probe 80 from a profilometer (not shown), and light reflected from the surface 78 may be detected by a detector 82. Roughness on the order of 1 nm to about 40 μm may be characterized using non-contact optical profilometry. In one example, the sample size imaged via non-contact optical profilometry is about 1.6 mm×1.6 mm (1600 μm×1600 μm). In another example, the sample size imaged via non-contact optical profilometry is about 0.8 mm×0.8 mm (800 μm×800 μm). In a further example, the sample size imaged via non-contact optical profilometry is about 0.4 mm×0.4 mm (400 μm×400 μm).

A third technique for characterizing the roughness of a surface uses a non-contact digital microscope in topography mode. A digital microscope topographer may be used for quantifying roughness that is too great (e.g., greater than about 40 μm) to be characterized by optical profilometery. A digital microscope topographer functions similarly to a non-contact optical profilometer, and the simplified schematic diagram shown in FIG. 13 may likewise be used to describe a digital microscope topographer. For example, as shown in FIG. 13, the surface 78 of the sample may be scanned with an optical probe 80 from a digital microscope (not shown), and light reflected from the surface 78 may be detected by the detector 82. Roughness on the order of about 1 μm to about 1 mm may be characterized using a digital microscope in topography mode. In one example, the sample size imaged via digital microscope in topography mode is about 8 mm×8 mm.

Many different roughness parameters may be used to characterize the degree of surface roughness of a sample, with different roughness parameters being calculated in specific ways and/or by using specific formulae. In one example, the roughness parameter used to describe surface roughness in accordance with the present disclosure is a profile roughness parameter. Representative profile roughness parameters include, but are not limited to, the arithmetic average of the roughness profile (Rₐ). In another example, the roughness parameter used to describe surface roughness in accordance with the present disclosure is peak-to-valley (PV) roughness.

Surface roughness of the lid, or at least a portion thereof adapted for contacting the mouth of a user (e.g., an outer surface, including but not limited to the drink spout 60, top wall 62, and/or liquid discharge outlet 64), may be one of several different values or fall within one of several different ranges. For example, it is within the scope of the present disclosure for the surface roughness (e.g., Rₐ surface roughness and/or PV surface roughness) to be one of the following values: about 1 nm, 2 nm, 3 nm, 4 nm, 5 nm, 6 nm, 7 nm, 8 nm, 9 nm, 10 nm, 11 nm, 12 nm, 13 nm, 14 nm, 15 nm, 16 nm, 17 nm, 18 nm, 19 nm, 20 nm, 21 nm, 22 nm, 23 nm, 24 nm, 25 nm, 26 nm, 27 nm, 28 nm, 29 nm, 30 nm, 31 nm, 32 nm, 33 nm, 34 nm, 35 nm, 36 nm, 37 nm, 38 nm, 39 nm, 40 nm, 41 nm, 42 nm, 43 nm, 44 nm, 45 nm, 46 nm, 47 nm, 48 nm, 49 nm, 50 nm, 51 nm, 52 nm, 53 nm, 54 nm, 55 nm, 56 nm, 57 nm, 58 nm, 59 nm, 60 nm, 61 nm, 62 nm, 63 nm, 64 nm, 65 nm, 66 nm, 67 nm, 68 nm, 69 nm, 70 nm, 71 nm, 72 nm, 73 nm, 74 nm, 75 nm, 76 nm, 77 nm, 78 nm, 79 nm, 80 nm, 81 nm, 82 nm, 83 nm, 84 nm, 85 nm, 86 nm, 87 nm, 88 nm, 89 nm, 90 nm, 91 nm, 92 nm, 93 nm, 94 nm, 95 nm, 96 nm, 97 nm, 98 nm, 99 nm, 100 nm, 101 nm, 102 nm, 103 nm, 104 nm, 105 nm, 106 nm, 107 nm, 108 nm, 109 nm, 110 nm, 111 nm, 112 nm, 113 nm, 114 nm, 115 nm, 116 nm, 117 nm, 118 nm, 119 nm, 120 nm, 121 nm, 122 nm, 123 nm, 124 nm, 125 nm, 126 nm, 127 nm, 128 nm, 129 nm, 130 nm, 131 nm, 132 nm, 133 nm, 134 nm, 135 nm, 136 nm, 137 nm, 138 nm, 139 nm, 140 nm, 141 nm, 142 nm, 143 nm, 144 nm, 145 nm, 146 nm, 147 nm, 148 nm, 149 nm, 150 nm, 151 nm, 152 nm, 153 nm, 154 nm, 155 nm, 156 nm, 157 nm, 158 nm, 159 nm, 160 nm, 161 nm, 162 nm, 163 nm, 164 nm, 165 nm, 166 nm, 167 nm, 168 nm, 169 nm, 170 nm, 171 nm, 172 nm, 173 nm, 174 nm, 175 nm, 176 nm, 177 nm, 178 nm, 179 nm, 180 nm, 181 nm, 182 nm, 183 nm, 184 nm, 185 nm, 186 nm, 187 nm, 188 nm, 189 nm, 190 nm, 191 nm, 192 nm, 193 nm, 194 nm, 195 nm, 196 nm, 197 nm, 198 nm, 199 nm, 200 nm, 201 nm, 202 nm, 203 nm, 204 nm, 205 nm, 206 nm, 207 nm, 208 nm, 209 nm, 210 nm, 211 nm, 212 nm, 213 nm, 214 nm, 215 nm, 216 nm, 217 nm, 218 nm, 219 nm, 220 nm, 221 nm, 222 nm, 223 nm, 224 nm, 225 nm, 226 nm, 227 nm, 228 nm, 229 nm, 230 nm, 231 nm, 232 nm, 233 nm, 234 nm, 235 nm, 236 nm, 237 nm, 238 nm, 239 nm, 240 nm, 241 nm, 242 nm, 243 nm, 244 nm, 245 nm, 246 nm, 247 nm, 248 nm, 249 nm, 250 nm, 251 nm, 252 nm, 253 nm, 254 nm, 255 nm, 256 nm, 257 nm, 258 nm, 259 nm, 260 nm, 261 nm, 262 nm, 263 nm, 264 nm, 265 nm, 266 nm, 267 nm, 268 nm, 269 nm, 270 nm, 271 nm, 272 nm, 273 nm, 274 nm, 275 nm, 276 nm, 277 nm, 278 nm, 279 nm, 280 nm, 281 nm, 282 nm, 283 nm, 284 nm, 285 nm, 286 nm, 287 nm, 288 nm, 289 nm, 290 nm, 291 nm, 292 nm, 293 nm, 294 nm, 295 nm, 296 nm, 297 nm, 298 nm, 299 nm, 300 nm, 301 nm, 302 nm, 303 nm, 304 nm, 305 nm, 306 nm, 307 nm, 308 nm, 309 nm, 310 nm, 311 nm, 312 nm, 313 nm, 314 nm, 315 nm, 316 nm, 317 nm, 318 nm, 319 nm, 320 nm, 321 nm, 322 nm, 323 nm, 324 nm, 325 nm, 326 nm, 327 nm, 328 nm, 329 nm, 330 nm, 331 nm, 332 nm, 333 nm, 334 nm, 335 nm, 336 nm, 337 nm, 338 nm, 339 nm, 340 nm, 341 nm, 342 nm, 343 nm, 344 nm, 345 nm, 346 nm, 347 nm, 348 nm, 349 nm, 350 nm, 351 nm, 352 nm, 353 nm, 354 nm, 355 nm, 356 nm, 357 nm, 358 nm, 359 nm, 360 nm, 361 nm, 362 nm, 363 nm, 364 nm, 365 nm, 366 nm, 367 nm, 368 nm, 369 nm, 370 nm, 371 nm, 372 nm, 373 nm, 374 nm, 375 nm, 376 nm, 377 nm, 378 nm, 379 nm, 380 nm, 381 nm, 382 nm, 383 nm, 384 nm, 385 nm, 386 nm, 387 nm, 388 nm, 389 nm, 390 nm, 391 nm, 392 nm, 393 nm, 394 nm, 395 nm, 396 nm, 397 nm, 398 nm, 399 nm, 400 nm, 401 nm, 402 nm, 403 nm, 404 nm, 405 nm, 406 nm, 407 nm, 408 nm, 409 nm, 410 nm, 411 nm, 412 nm, 413 nm, 414 nm, 415 nm, 416 nm, 417 nm, 418 nm, 419 nm, 420 nm, 421 nm, 422 nm, 423 nm, 424 nm, 425 nm, 426 nm, 427 nm, 428 nm, 429 nm, 430 nm, 431 nm, 432 nm, 433 nm, 434 nm, 435 nm, 436 nm, 437 nm, 438 nm, 439 nm, 440 nm, 441 nm, 442 nm, 443 nm, 444 nm, 445 nm, 446 nm, 447 nm, 448 nm, 449 nm, 450 nm, 451 nm, 452 nm, 453 nm, 454 nm, 455 nm, 456 nm, 457 nm, 458 nm, 459 nm, 460 nm, 461 nm, 462 nm, 463 nm, 464 nm, 465 nm, 466 nm, 467 nm, 468 nm, 469 nm, 470 nm, 471 nm, 472 nm, 473 nm, 474 nm, 475 nm, 476 nm, 477 nm, 478 nm, 479 nm, 480 nm, 481 nm, 482 nm, 483 nm, 484 nm, 485 nm, 486 nm, 487 nm, 488 nm, 489 nm, 490 nm, 491 nm, 492 nm, 493 nm, 494 nm, 495 nm, 496 nm, 497 nm, 498 nm, 499 nm, or 500 nm.

It is likewise within the scope of the present disclosure for the surface roughness to fall within one of many different ranges. In a first set of ranges, the surface roughness of the lid is one of the following ranges: about 1 nm to 500 nm, 2 nm to 500 nm, 3 nm to 500 nm, 4 nm to 500 nm, 5 nm to 500 nm, 10 nm to 500 nm, 15 nm to 500 nm, 20 nm to 500 nm, 25 nm to 500 nm, 30 nm to 500 nm, 35 nm to 500 nm, 40 nm to 500 nm, 45 nm to 500 nm, 50 nm to 500 nm, 55 nm to 500 nm, 60 nm to 500 nm, 65 nm to 500 nm, 70 nm to 500 nm, 75 nm to 500 nm, 80 nm to 500 nm, 85 nm to 500 nm, 90 nm to 500 nm, 95 nm to 500 nm, 100 nm to 500 nm, 105 nm to 500 nm, 110 nm to 500 nm, 115 nm to 500 nm, 120 nm to 500 nm, 125 nm to 500 nm, 130 nm to 500 nm, 135 nm to 500 nm, 140 nm to 500 nm, 145 nm to 500 nm, 150 nm to 500 nm, 155 nm to 500 nm, 160 nm to 500 nm, 165 nm to 500 nm, 170 nm to 500 nm, 175 nm to 500 nm, 180 nm to 500 nm, 185 nm to 500 nm, 190 nm to 500 nm, 195 nm to 500 nm, 200 nm to 500 nm, 205 nm to 500 nm, 210 nm to 500 nm, 215 nm to 500 nm, 220 nm to 500 nm, 225 nm to 500 nm, 230 nm to 500 nm, 235 nm to 500 nm, 240 nm to 500 nm, 245 nm to 500 nm, 250 nm to 500 nm, 255 nm to 500 nm, 260 nm to 500 nm, 265 nm to 500 nm, 270 nm to 500 nm, 275 nm to 500 nm, 280 nm to 500 nm, 285 nm to 500 nm, 290 nm to 500 nm, 295 nm to 500 nm, 300 nm to 500 nm, 305 nm to 500 nm, 310 nm to 500 nm, 315 nm to 500 nm, 320 nm to 500 nm, 325 nm to 500 nm, 330 nm to 500 nm, 335 nm to 500 nm, 340 nm to 500 nm, 345 nm to 500 nm, and 350 nm to 500 nm. In a second set of ranges, the surface roughness of the lid is one of the following ranges: about 5 nm to 499 nm, 5 nm to 495 nm, 5 nm to 490 nm, 5 nm to 485 nm, 5 nm to 480 nm, 5 nm to 475 nm, 5 nm to 470 nm, 5 nm to 465 nm, 5 nm to 460 nm, 5 nm to 455 nm, 5 nm to 450 nm, 5 nm to 445 nm, 5 nm to 440 nm, 5 nm to 435 nm, 5 nm to 430 nm, 5 nm to 425 nm, 5 nm to 420 nm, 5 nm to 415 nm, 5 nm to 410 nm, 5 nm to 405 nm, 5 nm to 400 nm, 5 nm to 395 nm, 5 nm to 390 nm, 5 nm to 385 nm, 5 nm to 380 nm, 5 nm to 375 nm, 5 nm to 370 nm, 5 nm to 365 nm, 5 nm to 360 nm, 5 nm to 355 nm, 5 nm to 350 nm, 5 nm to 345 nm, 5 nm to 340 nm, 5 nm to 335 nm, 5 nm to 330 nm, 5 nm to 325 nm, 5 nm to 320 nm, 5 nm to 315 nm, 5 nm to 310 nm, 5 nm to 305 nm, 5 nm to 300 nm, 5 nm to 295 nm, 5 nm to 290 nm, 5 nm to 285 nm, 5 nm to 280 nm, 5 nm to 275 nm, 5 nm to 270 nm, 5 nm to 265 nm, 5 nm to 260 nm, 5 nm to 255 nm, 5 nm to 250 nm, 5 nm to 245 nm, 5 nm to 240 nm, 5 nm to 235 nm, 5 nm to 230 nm, 5 nm to 225 nm, 5 nm to 220 nm, 5 nm to 215 nm, 5 nm to 210 nm, 5 nm to 205 nm, 5 nm to 200 nm, 5 nm to 195 nm, 5 nm to 190 nm, 5 nm to 185 nm, 5 nm to 180 nm, 5 nm to 175 nm, 5 nm to 170 nm, 5 nm to 165 nm, 5 nm to 160 nm, 5 nm to 155 nm, 5 nm to 150 nm, 5 nm to 145 nm, 5 nm to 140 nm, 5 nm to 135 nm, 5 nm to 130 nm, 5 nm to 125 nm, 5 nm to 120 nm, 5 nm to 115 nm, 5 nm to 110 nm, 5 nm to 105 nm, 5 nm to 100 nm, 5 nm to 95 nm, 5 nm to 90 nm, 5 nm to 85 nm, 5 nm to 80 nm, 5 nm to 75 nm, 5 nm to 70 nm, 5 nm to 65 nm, 5 nm to 60 nm, 5 nm to 55 nm, 5 nm to 50 nm, 5 nm to 45 nm, 5 nm to 40 nm, and 5 nm to 35 nm. In a third set of ranges, the surface roughness of the lid is one of the following ranges: about 4 nm to 499 nm, 5 nm to 498 nm, 10 nm to 495 nm, 15 nm to 490 nm, 20 nm to 485 nm, 25 nm to 480 nm, 30 nm to 475 nm, 35 nm to 470 nm, 40 nm to 465 nm, 45 nm to 460 nm, 50 nm to 455 nm, 55 nm to 450 nm, 60 nm to 445 nm, 65 nm to 440 nm, 70 nm to 435 nm, 75 nm to 430 nm, 80 nm to 425 nm, 85 nm to 420 nm, 90 nm to 415 nm, 95 nm to 410 nm, 100 nm to 405 nm, 105 nm to 400 nm, 110 nm to 395 nm, 115 nm to 390 nm, 120 nm to 385 nm, 125 nm to 380 nm, 130 nm to 375 nm, 135 nm to 370 nm, 140 nm to 365 nm, 145 nm to 360 nm, 150 nm to 355 nm, 155 nm to 350 nm, 160 nm to 345 nm, 165 nm to 340 nm, 170 nm to 335 nm, 175 nm to 330 nm, 180 nm to 325 nm, 185 nm to 320 nm, 190 nm to 315 nm, 195 nm to 310 nm, and 200 nm to 305 nm. In a fourth set of ranges, the surface roughness of the lid is one of the following ranges: about 5 nm to 365 nm, 7 nm to 360 nm, 12 nm to 355 nm, 13 nm to 350 nm, 14 nm to 345 nm, and 15 nm to 340 nm.

In some embodiments, the Rₐ surface roughness of a lid in accordance with the present disclosure is determined by non-contact optical profilometry. In some examples, the Rₐ surface roughness of a lid in accordance with the present disclosure, as determined by non-contact optical profilometry on an image area of about 1.6 μm×1.60 μm and/or an image area of about 400 μm×400 μm, is one of the above-described nanoscale (nm) values and/or within one of the above-described ranges of nanoscale (nm) values.

In other embodiments, the Rₐ surface roughness of a lid in accordance with the present disclosure is determined by atomic force microscopy. In some examples, the Rₐ surface roughness of a lid in accordance with the present disclosure, as determined by AFM on an image area of about 20 μm×20 μm, is one of the above-described nanoscale (nm) values and/or within one of the above-described ranges of nanoscale (nm) values.

In further embodiments, the Rₐ surface roughness of a lid in accordance with the present disclosure is determined by a digital microscope in topography mode. In some examples, the Rₐ surface roughness of a lid in accordance with the present disclosure, as determined by a digital microscope in topography mode on an image area of about 8 mm×8 mm, is one of the above-described nanoscale (nm) values and/or within one of the above-described ranges of nanoscale (nm) values.

In some embodiments, the PV surface roughness of a lid in accordance with the present disclosure is determined by non-contact optical profilometry. In some examples, the PV surface roughness of a lid in accordance with the present disclosure, as determined by non-contact optical profilometry on an image area of about 1.6 μm×1.6 μm and/or an image area of about 400 μm×400 μm, is one of the above-described nanoscale (nm) values and/or within one of the above-described ranges of nanoscale (nm) values.

In other embodiments, the PV surface roughness of a lid in accordance with the present disclosure is determined by AFM. In some embodiments, the PV surface roughness of a lid in accordance with the present disclosure, determined by AFM on an image area of about 20 μm×20 μm, is one of the above-described nanoscale (nm) values and/or within one of the above-described ranges of nanoscale (nm) values.

In further embodiments, the PV surface roughness of a lid in accordance with the present disclosure is determined by a digital microscope in topography mode. In some embodiments, the PV surface roughness of a lid in accordance with the present disclosure, as determined by a digital microscope in topography mode on an image area of about 8 mm×8 mm, is one of the above-described nanoscale (nm) values and/or within one of the above-described ranges of nanoscale (nm) values.

As described above, the surface roughness of a lid in accordance with the present disclosure—or of at least a portion of the lid adapted for contacting the mouth of a user (e.g., an outer surface, including but not limited to the drink spout 60, top wall 62, and/or liquid discharge outlet 64) may be a nanoscale (nm) value. Alternatively or additionally, in some embodiments, the surface of a lid or of at least a portion thereof may be on the order of microns (μm) or millimeters (mm).

Microscale surface roughness of the lid, or at least a portion thereof configured to contact the mouth of a user (e.g., an outer surface, including but not limited to the drink spout 60, top wall 62, and/or liquid discharge outlet 64), may be one of several different values or fall within one of several different ranges. For example, it is within the scope of the present disclosure for the surface roughness (e.g., Rₐ surface roughness and/or PV surface roughness) to be one of the following values: about 0.01 μm, 0.02 μm, 0.03 μm, 0.04 μm, 0.05 μm, 0.06 μm, 0.07 μm, 0.08 μm, 0.09 μm, 1.0 μm, 1.1 μm, 1.2 μm, 1.3 μm, 1.4 μm, 1.5 μm, 1.6 μm, 1.7 μm, 1.8 μm, 1.9 μm, 2.0 μm, 2.1 μm, 2.2 μm, 2.3 μm, 2.4 μm, 2.5 μm, 2.6 μm, 2.7 μm, 2.8 μm, 2.9 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, 30 μm, 31 μm, 32 μm, 33 μm, 34 μm, 35 μm, 36 μm, 37 μm, 38 μm, 39 μm, 40 μm, 41 μm, 42 μm, 43 μm, 44 μm, 45 μm, 46 μm, 47 μm, 48 μm, 49 μm, 50 μm, 51 μm, 52 μm, 53 μm, 54 μm, 55 μm, 56 μm, 57 μm, 58 μm, 59 μm, 60 μm, 61 μm, 62 μm, 63 μm, 64 μm, 65 μm, 66 μm, 67 μm, 68 μm, 69 μm, 70 μm, 71 μm, 72 μm, 73 μm, 74 μm, 75 μm, 76 μm, 77 μm, 78 μm, 79 μm, 80 μm, 81 μm, 82 μm, 83 μm, 84 μm, 85 μm, 86 μm, 87 μm, 88 μm, 89 μm, 90 μm, 91 μm, 92 μm, 93 μm, 94 μm, 95 μm, 96 μm, 97 μm, 98 μm, 99 μm, 100 μm, 101 μm, 102 μm, 103 μm, 104 μm, 105 μm, 106 μm, 107 μm, 108 μm, 109 μm, 110 μm, 111 jinn, 112 jinn, 113 μm, 114 jinn, 115 jinn, 116 μm, 117 μm, 118 μm, 119 μm, 120 μm, 121 μm, 122 μm, 123 μm, 124 μm, 125 μm, 126 μm, 127 μm, 128 μm, 129 μm, 130 μm, 131 μm, 132 jinn, 133 μm, 134 μm, 135 μm, 136 μm, 137 μm, 138 μm, 139 μm, 140 μm, 141 μm, 142 μm, 143 μm, 144 μm, 145 μm, 146 μm, 147 μm, 148 μm, 149 μm, 150 μm, 151 μm, 152 jinn, 153 μm, 154 μm, 155 μm, 156 μm, 157 μm, 158 μm, 159 μm, 160 μm, 161 μm, 162 jinn, 163 μm, 164 μm, 165 μm, 166 μm, 167 μm, 168 μm, 169 μm, 170 μm, 171 μm, 172 jinn, 173 μm, 174 μm, 175 μm, 176 μm, 177 μm, 178 μm, 179 μm, 180 μm, 181 μm, 182 jinn, 183 μm, 184 μm, 185 μm, 186 μm, 187 μm, 188 μm, 189 μm, 190 μm, 191 μm, 192 jinn, 193 μm, 194 μm, 195 μm, 196 μm, 197 μm, 198 μm, 199 μm, 200 μm, 201 μm, 202 μm, 203 μm, 204 μm, 205 μm, 206 μm, 207 μm, 208 μm, 209 μm, 210 μm, 211 μm, 212 μm, 213 μm, 214 μm, 215 μm, 216 μm, 217 μm, 218 μm, 219 μm, 220 μm, 221 μm, 222 μm, 223 μm, 224 μm, 225 μm, 226 μm, 227 μm, 228 μm, 229 μm, 230 μm, 231 μm, 232 μm, 233 μm, 234 μm, 235 μm, 236 μm, 237 μm, 238 μm, 239 μm, 240 μm, 241 μm, 242 μm, 243 μm, 244 μm, 245 μm, 246 μm, 247 μm, 248 μm, 249 μm, 250 μm, 251 μm, 252 μm, 253 μm, 254 μm, 255 μm, 256 μm, 257 μm, 258 μm, 259 μm, 260 μm, 261 μm, 262 μm, 263 μm, 264 μm, 265 μm, 266 μm, 267 μm, 268 μm, 269 μm, 270 μm, 271 μm, 272 μm, 273 μm, 274 μm, 275 μm, 276 μm, 277 μm, 278 μm, 279 μm, 280 μm, 281 μm, 282 μm, 283 μm, 284 μm, 285 μm, 286 μm, 287 μm, 288 μm, 289 μm, 290 μm, 291 μm, 292 μm, 293 μm, 294 μm, 295 μm, 296 μm, 297 μm, 298 μm, 299 μm, 300 μm, 301 μm, 302 μm, 303 μm, 304 μm, 305 μm, 306 μm, 307 μm, 308 μm, 309 μm, 310 μm, 311 μm, 312 inn, 313 μm, 314 μm, 315 μm, 316 μm, 317 μm, 318 μm, 319 μm, 320 μm, 321 μm, 322 μm, 323 μm, 324 μm, 325 μm, 326 μm, 327 μm, 328 μm, 329 μm, 330 μm, 331 μm, 332 μm, 333 μm, 334 μm, 335 μm, 336 μm, 337 μm, 338 μm, 339 μm, 340 μm, 341 μm, 342 μm, 343 μm, 344 μm, 345 μm, 346 μm, 347 μm, 348 μm, 349 μm, 350 μm, 351 μm, 352 μm, 353 μm, 354 μm, 355 μm, 356 μm, 357 μm, 358 μm, 359 μm, 360 μm, 361 μm, 362 μm, 363 μm, 364 μm, 365 μm, 366 μm, 367 μm, 368 μm, 369 μm, 370 μm, 371 μm, 372 μm, 373 μm, 374 μm, 375 μm, 376 μm, 377 μm, 378 μm, 379 μm, 380 μm, 381 μm, 382 μm, 383 μm, 384 μm, 385 μm, 386 μm, 387 μm, 388 μm, 389 μm, 390 μm, 391 μm, 392 μm, 393 μm, 394 μm, 395 μm, 396 μm, 397 μm, 398 μm, 399 μm, 400 μm, 401 μm, 402 μm, 403 μm, 404 μm, 405 μm, 406 μm, 407 μm, 408 μm, 409 μm, 410 μm, 411 μm, 412 μm, 413 μm, 414 μm, 415 μm, 416 μm, 417 μm, 418 μm, 419 μm, 420 μm, 421 μm, 422 μm, 423 μm, 424 μm, 425 μm, 426 μm, 427 μm, 428 μm, 429 μm, 430 μm, 431 μm, 432 μm, 433 μm, 434 μm, 435 μm, 436 μm, 437 μm, 438 μm, 439 μm, 440 μm, 441 μm, 442 μm, 443 μm, 444 μm, 445 μm, 446 μm, 447 μm, 448 μm, 449 μm, 450 μm, 451 μm, 452 μm, 453 μm, 454 μm, 455 μm, 456 μm, 457 μm, 458 μm, 459 μm, 460 μm, 461 μm, 462 μm, 463 μm, 464 μm, 465 μm, 466 μm, 467 μm, 468 μm, 469 μm, 470 μm, 471 μm, 472 μm, 473 μm, 474 μm, 475 μm, 476 μm, 477 μm, 478 μm, 479 μm, 480 μm, 481 μm, 482 μm, 483 μm, 484 μm, 485 μm, 486 μm, 487 μm, 488 μm, 489 μm, 490 μm, 491 μm, 492 μm, 493 μm, 494 μm, 495 μm, 496 μm, 497 μm, 498 μm, 499 μm, or 500 μm.

It is likewise within the scope of the present disclosure for the microscale surface roughness to fall within one of many different ranges. In a first set of ranges, the surface roughness of the lid is one of the following ranges: about 0.01 μm to 400 μm, 0.02 μm to 400 μm, 0.03 μm to 400 μm, 0.04 μm to 400 μm, 0.05 μm to 400 μm, 0.06 μm to 400 μm, 0.07 μm to 400 μm, 0.08 μm to 400 μm, 0.09 μm to 400 μm, 1.0 μm to 400 μm, 1.1 μm to 400 μm, 1.2 μm to 400 μm, 1.3 μm to 400 μm, 1.4 μm to 400 μm, 1.5 μm to 400 μm, 1.6 μm to 400 μm, 1.7 μm to 400 μm, 1.8 μm to 400 μm, 1.9 μm to 400 μm, 2.0 μm to 400 μm, 2.1 μm to 400 μm, 2.2 μm to 400 μm, 2.3 μm to 400 μm, 2.4 μm to 400 μm, 2.5 μm to 400 μm, 2.6 μm to 400 μm, 2.7 μm to 400 μm, 2.8 μm to 400 μm, 2.9 μm to 400 μm, 3 μm to 400 μm, 4 μm to 400 μm, 5 μm to 400 μm, 10 μm to 400 μm, 15 μm to 400 μm, 20 μm to 400 μm, 25 μm to 400 μm, 30 μm to 400 μm, 35 μm to 400 μm, 40 μm to 400 μm, 45 μm to 400 μm, 50 μm to 400 μm, 55 μm to 400 μm, 60 μm to 400 μm, 65 μm to 400 μm, 70 μm to 400 μm, 75 μm to 400 μm, 80 μm to 400 μm, 85 μm to 400 μm, 90 μm to 400 μm, 95 μm to 400 μm, 100 μm to 400 μm, 105 μm to 400 μm, 110 μm to 400 μm, 115 μm to 400 μm, 120 μm to 400 μm, 125 μm to 400 μm, 130 μm to 400 μm, 135 μm to 400 μm, 140 μm to 400 μm, 145 μm to 400 μm, 150 μm to 400 μm, 155 μm to 400 μm, 160 μm to 400 μm, 165 μm to 400 μm, 170 μm to 400 μm, 175 μm to 400 μm, 180 μm to 400 μm, 185 μm to 400 μm, 190 μm to 400 μm, 195 μm to 400 μm, 200 μm to 400 μm, 205 μm to 400 μm, 210 μm to 400 μm, 215 μm to 400 μm, 220 μm to 400 μm, and 225 μm to 400 μm. In a second set of ranges, the surface roughness of the lid is one of the following ranges: about 0.05 μm to 399 μm, 0.05 μm to 395 μm, 0.05 μm to 390 μm, 0.05 μm to 385 μm, 0.05 μm to 380 μm, 0.05 μm to 375 μm, 0.05 μm to 370 μm, 0.05 μm to 365 μm, 0.05 μm to 360 μm, 0.05 μm to 355 μm, 0.05 μm to 350 μm, 0.05 μm to 345 μm, 0.05 μm to 340 μm, 0.05 μm to 335 μm, 0.05 μm to 330 μm, 0.05 μm to 325 μm, 0.05 μm to 320 μm, 0.05 μm to 315 μm, 0.05 μm to 310 μm, 0.05 μm to 305 μm, 0.05 μm to 300 μm, 0.05 μm to 295 μm, 0.05 μm to 290 μm, 0.05 μm to 285 μm, 0.05 μm to 280 μm, 0.05 μm to 275 μm, 0.05 μm to 270 μm, 0.05 μm to 265 μm, 0.05 μm to 260 μm, 0.05 μm to 255 μm, 0.05 μm to 250 μm, 0.05 μm to 245 μm, 0.05 μm to 240 μm, 0.05 μm to 235 μm, 0.05 μm to 230 μm, 0.05 μm to 225 μm, 0.05 μm to 220 μm, 0.05 μm to 215 μm, 0.05 μm to 210 μm, 0.05 μm to 205 μm, 0.05 μm to 200 μm, 0.05 μm to 195 μm, 0.05 μm to 190 μm, 0.05 μm to 185 μm, 0.05 μm to 180 μm, 0.05 μm to 175 μm, 0.05 μm to 170 μm, 0.05 μm to 165 μm, 0.05 μm to 160 μm, 0.05 μm to 155 μm, 0.05 μm to 150 μm, 0.05 μm to 145 μm, 0.05 μm to 140 μm, 0.05 μm to 135 μm, 0.05 μm to 130 μm, 0.05 μm to 125 μm, 0.05 μm to 120 μm, 0.05 μm to 115 μm, 0.05 μm to 110 μm, 0.05 μm to 105 μm, 0.05 μm to 100 μm, 0.05 μm to 95 μm, 0.05 μm to 90 μm, 0.05 μm to 85 μm, 0.05 μm to 80 μm, 0.05 μm to 75 μm, 0.05 μm to 70 μm, 0.05 μm to 65 μm, 0.05 μm to 60 μm, 0.05 μm to 55 μm, 0.05 μm to 50 μm, 0.05 μm to 45 μm, 0.05 μm to 40 μm. In a third set of ranges, the surface roughness of the lid is one of the following ranges: about 0.01 μm to 399 μm, 0.02 μm to 395 μm, 0.03 μm to 390 μm, 0.04 μm to 385 μm, 0.05 μm to 380 μm, 0.06 μm to 375 μm, 0.07 μm to 370 μm, 0.08 μm to 365 μm, 0.09 μm to 360 μm, 1 μm to 355 μm, 1.1 μm to 350 μm, 1.2 μm to 345 μm, 1.3 μm to 340 μm, 1.4 μm to 335 μm, 1.5 μm to 330 μm, 1.6 μm to 325 μm, 1.7 μm to 320 μm, 1.8 μm to 315 μm, 1.9 μm to 310 μm, 2.0 μm to 305 μm, 2.1 μm to 300 μm, 2.2 μm to 295 μm, 2.3 μm to 290 μm, 2.4 μm to 285 μm, 2.5 μm to 280 μm, 2.6 μm to 275 μm, 2.7 μm to 270 μm, 2.8 μm to 265 μm, 2.9 μm to 260 μm, 3 μm to 255 μm, 4 μm to 250 μm, 5 μm to 245 μm, 10 μm to 240 μm, 15 μm to 235 μm, 20 μm to 230 μm, 25 μm to 225 μm, 30 μm to 220 μm, 35 μm to 215 μm, 40 μm to 210 μm, 45 μm to 205 μm, 50 μm to 200 μm, 45 μm to 195 μm, and 40 μm to 190 μm. In a fourth set of ranges, the surface roughness of the lid is one of the following ranges: about 0.05 μm to 250 μm, 0.1 μm to 240 μm, 1 μm to 250 μm, 1 μm to 235 μm, 35 μm to 205 μm, 40 μm to 200 μm, and 45 μm to 199 μm.

In some embodiments, the Rₐ surface roughness of a lid in accordance with the present disclosure is determined by non-contact optical profilometry. In some examples, the Rₐ surface roughness of a lid in accordance with the present disclosure, as determined by non-contact optical profilometry on an image area of about 1.6 μm×1.60 μm and/or an image area of about 400 μm×400 μm, is one of the above-described microscale (μm) values and/or within one of the above-described ranges of microscale (μm) values.

In other embodiments, the Rₐ surface roughness of a lid in accordance with the present disclosure is determined by atomic force microscopy. In some examples, the Rₐ surface roughness of a lid in accordance with the present disclosure, as determined by AFM on an image area of about 20 μm×20 μm, is one of the above-described microscale (μm) values and/or within one of the above-described ranges of microscale (μm) values.

In further embodiments, the Rₐ surface roughness of a lid in accordance with the present disclosure is determined by a digital microscope in topography mode. In some examples, the Rₐ surface roughness of a lid in accordance with the present disclosure, as determined by a digital microscope in topography mode on an image area of about 8 mm×8 mm, is one of the above-described microscale (μm) values and/or within one of the above-described ranges of microscale (μm) values.

In some embodiments, the PV surface roughness of a lid in accordance with the present disclosure is determined by non-contact optical profilometry. In some examples, the PV surface roughness of a lid in accordance with the present disclosure, as determined by non-contact optical profilometry on an image area of about 1.6 μm×1.6 μm and/or an image area of about 400 μm×400 μm, is one of the above-described microscale (μm) values and/or within one of the above-described ranges of microscale (μm) values.

In other embodiments, the PV surface roughness of a lid in accordance with the present disclosure is determined by AFM. In some embodiments, the PV surface roughness of a lid in accordance with the present disclosure, as determined by AFM on an image area of about 20 μm×20 μm, is one of the above-described microscale (μm) values and/or within one of the above-described ranges of microscale (μm) values.

In further embodiments, the PV surface roughness of a lid in accordance with the present disclosure is determined by a digital microscope in topography mode. In some embodiments, the PV surface roughness of a lid in accordance with the present disclosure, as determined by a digital microscope in topography mode on an image area of about 8 mm×8 mm, is one of the above-described microscale (μm) values and/or within one of the above-described ranges of microscale (μm) values.

In an example, a lid may have a thermal conductivity of about 0.05 W/(m*K) to 0.3 W/(m*K), a density of about 0.5 g/cm³ to 0.85 g/cm³, an Rₐ surface roughness of about 20 nm to 50 nm (e.g., about 30 nm to 40 nm) as measured by optical profilometry on an image area of about 400 μm×400 μm, an Rₐ surface roughness of about 325 nm to 350 nm (e.g., about 330 nm to 345 nm) as measured by optical profilometry on an image area of about 1.6 μm×1.6 μm, a PV surface roughness of about 155 nm to 185 nm (e.g., about 160 nm to 180 nm) as measured by optical profilometry on an image area of about 400 μm×400 μm, and/or a PV surface roughness of about 1.60 μm to 1.80 μm (e.g., about 1.65 μm to 1.75 μm) as measured by optical profilometry on an image area of about 1.6 μm×1.6 μm. In another example, a lid may have a thermal conductivity of about 0.05 W/(m*K) to 0.3 W/(m*K), a density of about 0.5 g/cm³ to 0.85 g/cm³, an Rₐ surface roughness of about 5 nm to 25 nm (e.g., about 10 nm to 20 nm) as measured by atomic force microscopy on an image area of about 20 μm×20 μm, and/or a PV surface roughness of about 70 nm to 110 nm (e.g., about 80 nm to 100 nm) as measured by atomic force microscopy on an image area of about 20 μm×20 μm. In a further example, a lid may have a thermal conductivity of about 0.05 W/(m*K) to 0.3 W/(m*K), a density of about 0.5 g/cm³ to 0.85 g/cm³, an Rₐ surface roughness of about 25 μm to 65 μm (e.g., about 35 μm to 60 μm) as measured by a digital microscope in topography mode on an image area of about 8 mm×8 mm, and/or a PV surface roughness of about 160 μm to 250 nm (e.g., about 175 μm to 235 μm) as measured by a digital microscope in topography mode on an image area of about 8 mm×8 mm.

In an example, a lid may have a thermal conductivity of about 0.1 W/(m*K) to 0.2 W/(m*K), a density of about 0.5 g/cm³ to 0.85 g/cm³, an Rₐ surface roughness of about 20 nm to 50 nm (e.g., about 30 nm to 40 nm) as measured by optical profilometry on an image area of about 400 μm×400 μm, an Rₐ surface roughness of about 325 nm to 350 nm (e.g., about 330 nm to 345 nm) as measured by optical profilometry on an image area of about 1.6 μm×1.6 μm, a PV surface roughness of about 155 nm to 185 nm (e.g., about 160 nm to 180 nm) as measured by optical profilometry on an image area of about 400 μm×400 μm, and/or a PV surface roughness of about 1.60 μm to 1.80 μm (e.g., about 1.65 μm to 1.75 μm) as measured by optical profilometry on an image area of about 1.6 μm×1.6 μm. In another example, a lid may have a thermal conductivity of about 0.1 W/(m*K) to 0.2 W/(m*K), a density of about 0.5 g/cm³ to 0.85 g/cm³, an Rₐ surface roughness of about 5 nm to 25 nm (e.g., about 10 nm to 20 nm) as measured by atomic force microscopy on an image area of about 20 μm×20 μm, and/or a PV surface roughness of about 70 nm to 110 nm (e.g., about 80 nm to 100 nm) as measured by atomic force microscopy on an image area of about 20 μm×20 μm. In a further example, a lid may have a thermal conductivity of about 0.1 W/(m*K) to 0.2 W/(m*K), a density of about 0.5 g/cm³ to 0.85 g/cm³, an Rₐ surface roughness of about 25 μm to 65 μm (e.g., about 35 μm to 60 μm) as measured by a digital microscope in topography mode on an image area of about 8 mm×8 mm, and/or a PV surface roughness of about 160 μm to 250 nm (e.g., about 175 μm to 235 μm) as measured by a digital microscope in topography mode on an image area of about 8 mm×8 mm.

In an example, a lid may have a thermal conductivity of about 0.13 W/(m*K) to 0.17 W/(m*K), a density of about 0.5 g/cm³ to 0.85 g/cm³, an Rₐ surface roughness of about 20 nm to 50 nm (e.g., about 30 nm to 40 nm) as measured by optical profilometry on an image area of about 400 μm×400 μm, an Rₐ surface roughness of about 325 nm to 350 nm (e.g., about 330 nm to 345 nm) as measured by optical profilometry on an image area of about 1.6 μm×1.6 μm, a PV surface roughness of about 155 nm to 185 nm (e.g., about 160 nm to 180 nm) as measured by optical profilometry on an image area of about 400 μm×400 μm, and/or a PV surface roughness of about 1.60 μm to 1.80 μm (e.g., about 1.65 μm to 1.75 μm) as measured by optical profilometry on an image area of about 1.6 μm×1.6 μm. In another example, a lid may have a thermal conductivity of about 0.13 W/(m*K) to 0.17 W/(m*K), a density of about 0.5 g/cm³ to 0.85 g/cm³, an Rₐ surface roughness of about 5 nm to 25 nm (e.g., about 10 nm to 20 nm) as measured by atomic force microscopy on an image area of about 20 μm×20 μm, and/or a PV surface roughness of about 70 nm to 110 nm (e.g., about 80 nm to 100 nm) as measured by atomic force microscopy on an image area of about 20 μm×20 μm. In a further example, a lid may have a thermal conductivity of about 0.13 W/(m*K) to 0.17 W/(m*K), a density of about 0.5 g/cm³ to 0.85 g/cm³, an Rₐ surface roughness of about 25 μm to 65 μm (e.g., about 35 μm to 60 μm) as measured by a digital microscope in topography mode on an image area of about 8 mm×8 mm, and/or a PV surface roughness of about 160 μm to 250 nm (e.g., about 175 μm to 235 μm) as measured by a digital microscope in topography mode on an image area of about 8 mm×8 mm.

In an example, a lid may have a thermal conductivity of about 0.05 W/(m*K) to 0.3 W/(m*K), a density of about 0.5 g/cm³ to 0.85 g/cm³, an Rₐ surface roughness of about 35 nm as measured by optical profilometry on an image area of about 400 μm×400 μm, an Rₐ surface roughness of about 339 nm as measured by optical profilometry on an image area of about 1.6 μm×1.6 μm, a PV surface roughness of about 170 nm as measured by optical profilometry on an image area of about 400 μm×400 μm, and/or a PV surface roughness of about 1.72 μm as measured by optical profilometry on an image area of about 1.6 μm×1.6 μm. In another example, a lid may have a thermal conductivity of about 0.05 W/(m*K) to 0.3 W/(m*K), a density of about 0.5 g/cm³ to 0.85 g/cm³, an Rₐ surface roughness of about 15 nm as measured by atomic force microscopy on an image area of about 20 μm×20 μm, and/or a PV surface roughness of about 90 nm as measured by atomic force microscopy on an image area of about 20 μm×20 μm. In a further example, a lid may have a thermal conductivity of about 0.05 W/(m*K) to 0.3 W/(m*K), a density of about 0.5 g/cm³ to 0.85 g/cm³, an Rₐ surface roughness of about 42.9 μm or about 52.6 μm as measured by a digital microscope in topography mode on an image area of about 8 mm×8 mm, and/or a PV surface roughness of about 195.2 μm or about 227.9 μm as measured by a digital microscope in topography mode on an image area of about 8 mm×8 mm.

In some embodiments, a lid in accordance with the present teachings may have any combination of thermal conductivity, density, and surface roughness as described herein.

### EXAMPLES

The following examples are set forth for purposes of illustration only. Parts and percentages appearing in such examples are by weight unless otherwise stipulated.

### Example 1

### Thermal Conductivity Testing

Eleven samples in stock sheets and one as a lid for a drink cup were tested for thermal conductivity at ambient temperature. The polypropylene sheets were produced by flat die extrusion.

Methods

The samples were measured by a ThermTest TPS 1500 Thermal Constants Analyzer (ThermTest Inc., Fredericton, NB, Canada), which meets the ISO standard ISO/DIS 22007-2.2. When using the ThermTest TPS 1500 Thermal Constants Analyzer (TPS System), the sample surrounds a TPS sensor included in the TPS System in all directions. Heat evolved in the sensor freely diffuses in all directions during the measurement. The solution to the thermal conductivity equation assumes the sensor is in an infinite medium, so the measurement and analysis of data must account for the limitation created by sample boundaries. Each sample was layered to increase the available sample thickness and allow for optimal measurement parameters. For layering, sample pieces were cut from the stock sample. Various layer amounts were used depending on thickness of the stock samples and the same number of layers was placed on each side of the TPS sensor for each sample. The orientation of the layers was also the same on each side of the TPS sensor.

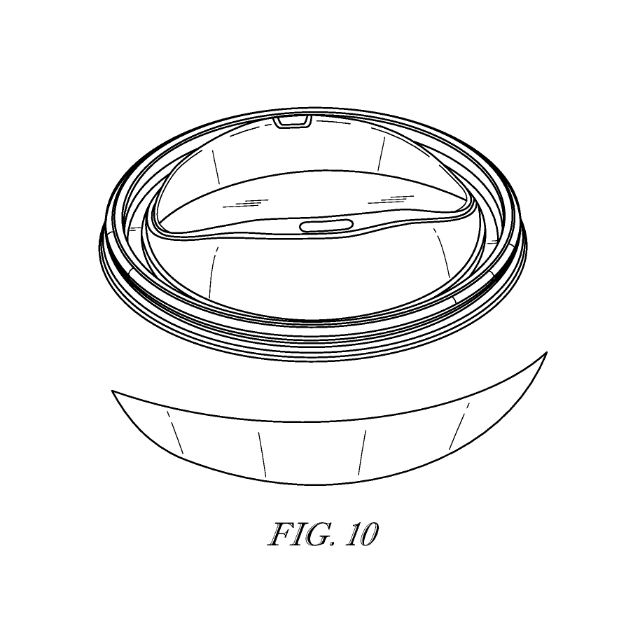

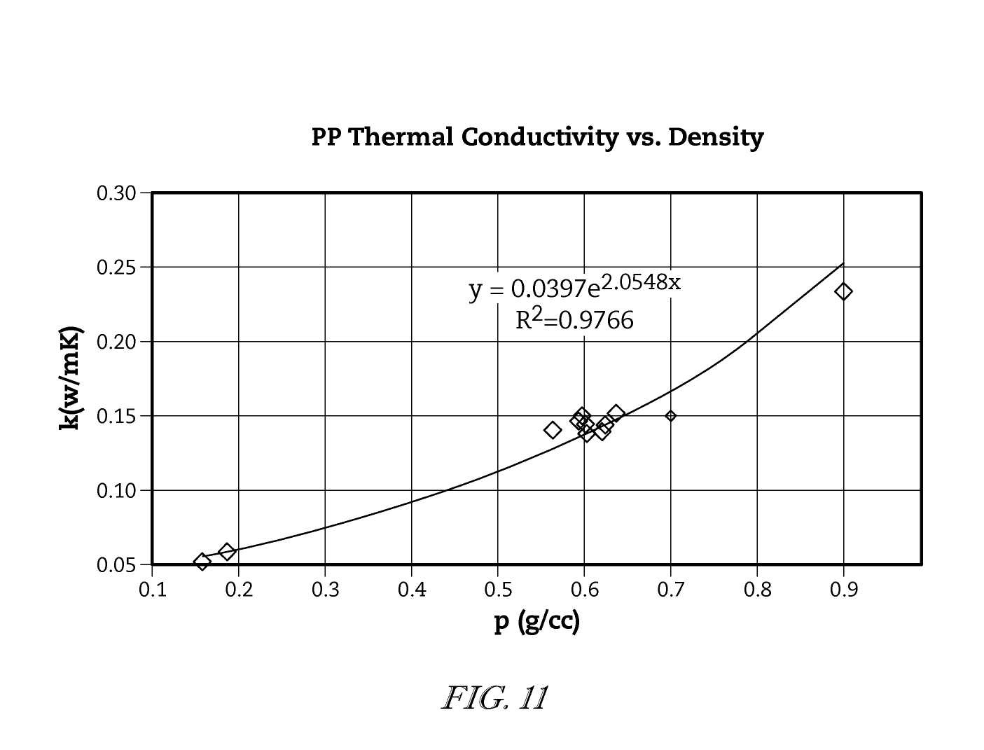

Sample Lid was received not in sheet stock like the other samples but as a formed lid for a drink cup. A test piece was removed from the same area of each lid (see FIG. 10) and layered like the sheet stock sample for testing.

Results

For each test sample, a measured constant pressure was applied to the sample sensor assembly using a pressure gauge and stand. From preliminary measurements, 25 lbs. of pressure was determined to be adequate to confirm good sample sensor contact without affecting the thermal properties of each sample. Each sample was measured multiple times (n equaled 5, 6, or 7) for conductivity. A 20 second test time and 0.015 watts of power were used for each measurement.

TABLE 1
Thermal Conductivity and Density of
Polypropylene Sheets, Polypropylene Lid,
and Polystyrene Sheets.

| | | | % PP |
|---|---|---|---|
| Sample | k (W/mK) | ρ (g/cm³) | Regrind |
| A | 0.1501 | 0.640 | 100 |
| B | 0.1387 | 0.568 | 50 |
| C | 0.1438 | 0.605 | 10 |
| D | 0.1482 | 0.600 | 5 |
| E | 0.1386 | 0.608 | 10 |
| Lid | 0.1511 | 0.700 | 10 |
| F | 0.1472 | 0.598 | 20 |
| G | 0.1436 | 0.630 | 80 |
| H | 0.1386 | 0.624 | 10 |
| I | 0.2333 | 0.900 | 0 |
| J | 0.0579 | 0.190 | 0 |
| K | 0.0514 | 0.160 | 0 |
| PS Black | 0.1719 | 1.050 | 0 |
| PS White | 0.1732 | 1.050 | 0 |

Samples I and J were sheets of cellular, non-aromatic polypropylene polymeric material, which did not include any regrind. Likewise, the polystyrene samples (PS) did not include any regrind polypropylene.

### Example 2

### Polypropylene Sheet Formation

Lids were produced according the formulation in Table 2. The nucleating agent was the chemical blowing agent (CBA) Hydrocerol® CF-40E only. No physical blowing agent (e.g., N₂) was used in producing the sheets of insulative non-aromatic polymeric material.

TABLE 2
Formulations Without and With Ground-Up Previously-Produced
Insulative Cellular Non-Aromatic Polymeric Material

| Non- | | | | | | ρ | ρ |
|---|---|---|---|---|---|---|---|
| regrind PP | Regrind | | CBA | Colorant | | sheet | sheet |
| layer* | % | CBA | % | % | Gauge | start | end |
| INSPIRE | 0 | CF-40E | 1 | 0 | 0.035 | 0.659 | 0.613 |
| 6025N | | | | | | | |
| INSPIRE | 10 | CF-40E | 1 | 0 | 0.032 | 0.611 | 0.605 |
| 6025N | | | | | | | |
| INSPIRE | 20 | CF-40E | 1 | 0 | 0.036 | 0.636 | 0.600 |
| 6025N | | | | | | | |
| INSPIRE | 40 | CF-40E | 1 | 0 | 0.034 | 0.697 | 0.568 |
| 6025N | | | | | | | |
| INSPIRE | 60 | CF-40E | 1 | 0 | 0.035 | 0.655 | 0.626 |
| 6025N | | | | | | | |
| INSPIRE | 80 | CF-40E | 1 | 0 | 0.033 | 0.718 | 0.633 |
| 6025N | | | | | | | |
| N/A | 100 | CF-40E | 1 | 0 | 0.034 | 0.661 | 0.619 |

*INSPIRE 6025N is a nucleated homopolymer polypropylene from Braskem.

Thus, ground-up previously-produced insulative cellular non-aromatic polymeric material in amounts of 0%, 10%, 20%, 40%, 60%, 80%, and 100% were used in formulations to produce sheets of insulative non-aromatic polymeric materials. These sheets were then use to form insulative lids in accordance with the present disclosure.

### Example 3

### Density Testing of Lid Spouts

The thermal conductivity data indicates that the spout 60 density should be 0.75 g/cm³ or less to have a thermal conductivity equal to a polystyrene lid and improved thermal conductivity when compared to an insulative non-aromatic polymeric material. Lid spout 60 density was determined for lids produced as described in Example 2.

TABLE 3
Lid Spout Densities

| PP Regrind % of Lid | Lid Spout Density (g/cm³) | Forming Technique |
|---|---|---|
| 0% | 0.699 | Male Mold |
| 10% | 0.750 | Male Mold |
| 10% | 0.730 | Female Mold |
| 20% | 0.831 | Male Mold |
| 40% | 0.810 | Male Mold |
| 60% | 0.796 | Male Mold |
| 80% | 0.762 | Male Mold |
| 100% | 0.810 | Male Mold |

Table 3 indicates that the lid spout 60 density increased with increased regrind polymeric material up to a percentage between about 20% and about 40%. The lid spout 60 density for about 40% regrind polymeric material was the same as the lid produced with about 100% regrind polymeric material. Additionally, the density of the spout 60 can be greater than the density of the rest of the lid.

### Example 4

### Density Testing of Lid Spouts and Center Panels

Various formulations were used to produce sample lids. Each sample was tested five times for the density in the spout 60 and in the center panel. The chemical blowing agent (CBA) was Hydrocerol® CF-40e for all samples. Each sample included varying amounts of a polypropylene resin and regrind polymeric material. The density values in Table 4 are an average of the five tests.

TABLE 4
Lid Densities

| | % PP | | Spout ρ | Center Panel |
|---|---|---|---|---|
| % Non-regrind PP | Regrind | % CBA | (g/cm³) | ρ (g/cm³) |
| 99% two melt | 0 | 1 | 0.8116 | 0.751 |
| random copolymer | | | | |
| 79.5% two melt | 19 | 1 | 0.8296 | 0.7506 |
| random copolymer | | | | |
| 59.5% two melt | 39.5 | 1 | 08576 | 0.8388 |
| random copolymer | | | | |
| 39.5% two melt | 59.5 | 1 | 0.7838 | 0.7694 |
| random copolymer | | | | |
| 19.5% two melt | 79.5 | 1 | 0.7818 | 0.6822 |
| random copolymer | | | | |
| 0 | 99 | 1 | 0.7838 | 0.7694 |
| 99% INSPIRE | 0 | 1 | 0.699 | 0.6804 |
| 6025N | | | | |
| 79.5% INSPIRE | 19 | 1 | 0.7616 | 0.7124 |
| 6025N | | | | |
| 59.5% INSPIRE | 39.5 | 1 | 0.7964 | 0.7246 |
| 6025N | | | | |
| 39.5% INSPIRE | 59.5 | 1 | 0.7712 | 0.7528 |
| 6025N | | | | |
| 19.5% INSPIRE | 79.5 | 1 | 0.8096 | 0.7638 |
| 6025N | | | | |
| 0 | 99 | 1 | 0.8312 | 0.7844 |

In this table % indicates the relative amount in w/w terms; not all % indications total 100;
INSPIRE 6025N is a nucleated homopolymer polypropylene from Braskem.

Through variations in the formulation, the spout of a cup lid may have a greater density that the center panel of the lid.

### Example 5

### Thermoformed Lids from Lower Density Sheet

Lids were thermoformed as described herein using polypropylene sheets having a density of about 0.6 g/cm³. Two different trials in the same overall example afforded lid spout 60 densities as listed in Table 5. Densities were measured on the front vertical wall of the lid spout (middle of wall as shown in FIG. 10).

TABLE 5
Lid Spout Densities
Lid Densities

| Test # | Trial 1 | Trial 2 | Average |
|---|---|---|---|
| 3 | 0.460 | 0.452 | 0.456 |
| 4 | 0.464 | 0.455 | 0.460 |
| 5 | 0.458 | 0.99 | 0.429 |
| 6 | 0.423 | 0.394 | 0.409 |
| 7 | 0.423 | 0.960 | 0.692 |
| 8 | 0.486 | 0.445 | 0.466 |
| 9 | 0.471 | 0.445 | 0.458 |
| 10 | 0.543 | 0.497 | 0.520 |

The lid spout density may be less than that of the sheet from which it is thermoformed.

### Example 6

### Thermoformed Lids from Lower Density Sheet

A trial production run was run using polypropylene sheets having a density of about 0.6 g/cm³, affording 47 samples for measurement of spout density. The average of the results is: 0.551 g/cm³ (minimum 0.394 g/cm³; maximum 0.788 g/cm³).

### Example 7

### Polypropylene Sheet Formation with Physical Blowing Agent

Polypropylene sheets were prepared using the chemical blowing agent (CBA) Hydrocerol® CF-40e with a physical blowing agent. Densities were measured as shown in Table 7.

TABLE 7
Densities of polypropylene sheets prepared using CBA with a gas.

| Resin | Resin % | CBA | CBA% | Gas | lbs/hr | ρ |
|---|---|---|---|---|---|---|
| INSPIRE | 99.9 | CF-40E | 0.1 | CO₂ | 1 | 0.414 |
| 6025N | | | | | | |
| INSPIRE | 99.9 | CF-40E | 0.1 | CO₂ | 2 | 0.25 |
| 6025N | | | | | | |

### Example 8

### Surface Roughness Measurements via Non-Contact Optical Profilometry and Atomic Force Microscopy

A section of a central closure portion of a plastic lid was cut and imaged using a ZEGAGE® non-contact optical profilometer and by atomic force microscopy (AFM).

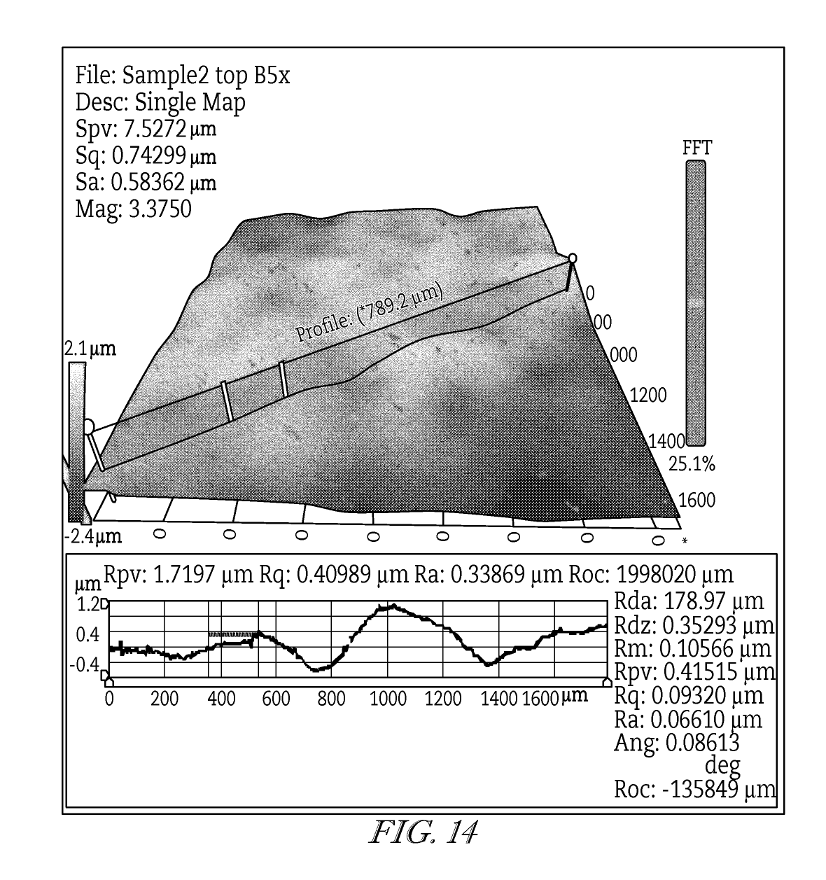

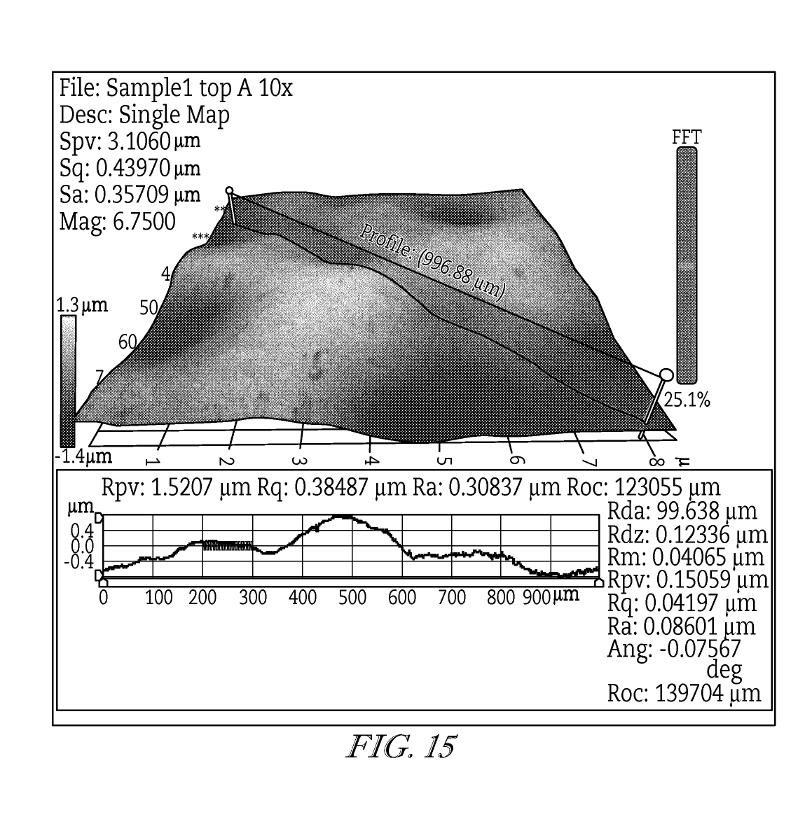

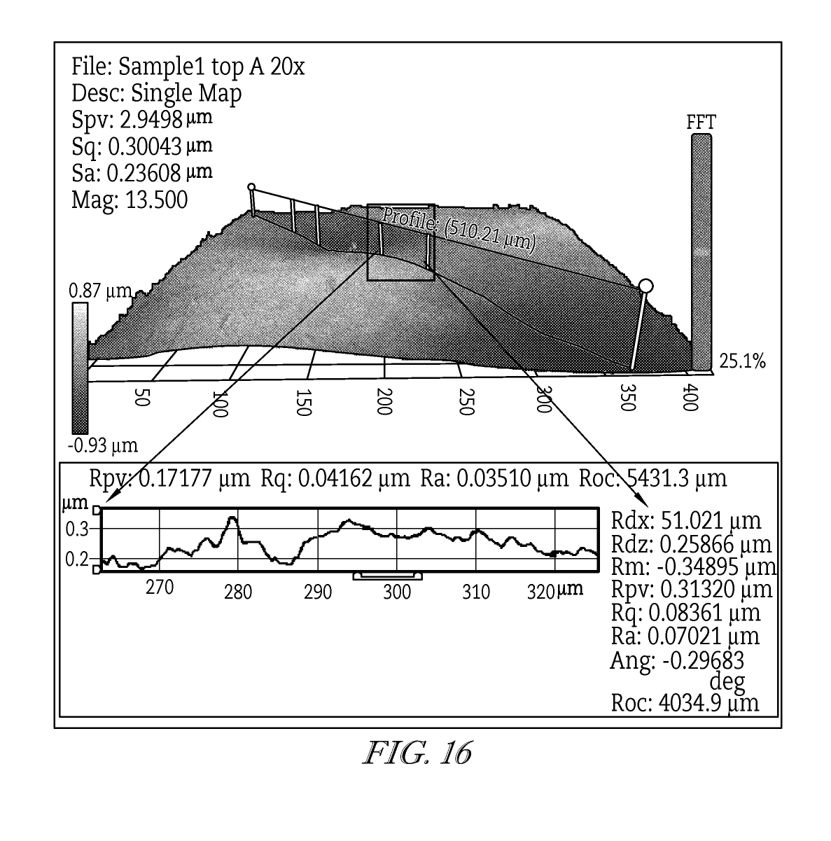

FIG. 14 shows the measurement results obtained by imaging a 1.6 mm×1.6 mm area of the drink lid via non-contact profilometry. FIG. 15 shows the measurement results obtained by imaging a 0.8 mm×0.8 mm area in a different section of the drink lid. Each of FIGS. 14 and 15 shows periodic, low-frequency surface undulations having a length of 0.4 mm to 0.6 mm and a height of 1-2 micron. Localized surface roughness is on the order of nanoscale, as described below in reference to FIG. 16.

FIG. 16 shows a higher resolution image of measurement results obtained by imaging a 400 μm×400 μm area via non-contact optical profilometry. The surface roughness section plot in the white border box at the center of FIG. 16 is shown at the bottom of the image. As shown in the plot at the bottom of FIG. 16, the nanoscale surface roughness varies between 0.02 μm and 0.1 μm (100 nm).

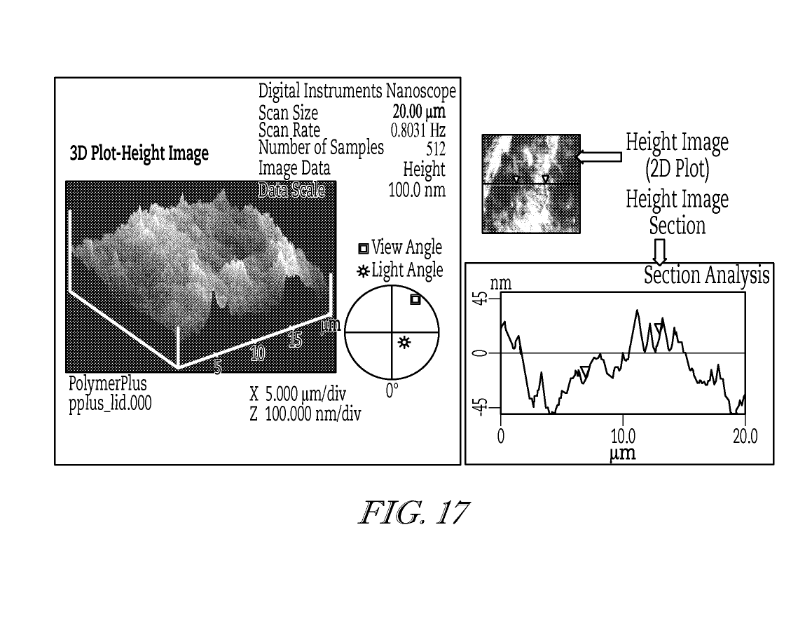

FIG. 17 shows the measurement results obtained by imaging a 20 μm×20 μm area of the drink lid via AFM. The three-dimensional plot shown in FIG. 17 reveals nanoscale roughness on the lid surface. The PV surface roughness approached 90 nm over the imaged area, and the localized roughness was on the order of 5 nm to 45 nm. These values are similar to the surface roughness values obtained using non-contact optical profilometry over the 400 μm×400 μm test area (i.e., a 20-times larger area) as shown in FIG. 16.

In summary, non-contact optical profilometry was used to image a 1.6 mm×1.6 mm lid area, and AFM was used to image a 20 μm×20 μm lid area. Thus, a 6,400 times larger area was imaged by the optical profilometry measurement.

The results of the optical profilometry showed lid surface undulations having a length scale of 0.4 mm to 0.6 mm. Higher resolution images revealed roughness on the submicron scale (i.e., a PV surface roughness of 0.17 μm for a 400 μm×400 μm image area, and an Ra surface roughness of 0.035 μm for a 400 μm×400 μm image area.

The results of the AFM showed PV surface roughness of 0.09 μm for a 20 μm×20 μm image area, and an Ra surface roughness of 0.015 μm for a 20 μm×20 μm image area.

The measurement data are summarized in Table 8 below.

TABLE 8
Surface Roughness Measurement Results Obtained via Optical
Profilometry and AFM.

| | Peak-to-Valley | |
|---|---|---|
| Technique | (PV) Roughness | Rₐ Roughness |
| Optical | 1.72 μm (1.6 μm × 1.6 μm) | 0.339 μm (1.6 μm × 1.6 μm) |
| Profilometry | 0.17 μm (400 μm × 400 μm) | 0.035 μm (400 μm × 400 μm) |
| Atomic Force | 0.09 μm (20 μm × 20 μm) | 0.015 μm (20 μm × 20 μm) |
| Microscopy | | |

### Example 9

### Surface Roughness Measurements Using a Digital Microscopy in Topography Mode

A section from a black-colored plastic part and a section from a white-colored plastic part were cut from the drink spout portions (see FIG. 10) of corresponding test lids. The surface roughness/topography of the convex (top) surface of the excised sections was imaged using a non-contact HIROX® digital microscope in topography mode. Due to the large PV surface roughness of the plastic parts (e.g., greater than about 40 μm), other methods such as atomic force microscopy and ZEGAGE® non-contact optical profilometery were not used for the surface roughness measurements. For example, AFM may be used to characterize surface roughness from less than about 1 nm to about 100 nm, and ZEGAGE® non-contact optical profilometery may be used to characterize surface roughness from about 1 nm up to about 40 μm. By contrast, a HIROX® digital microscope in topography mode may be used to characterize surface roughness from about 1 μm to about 1 mm.

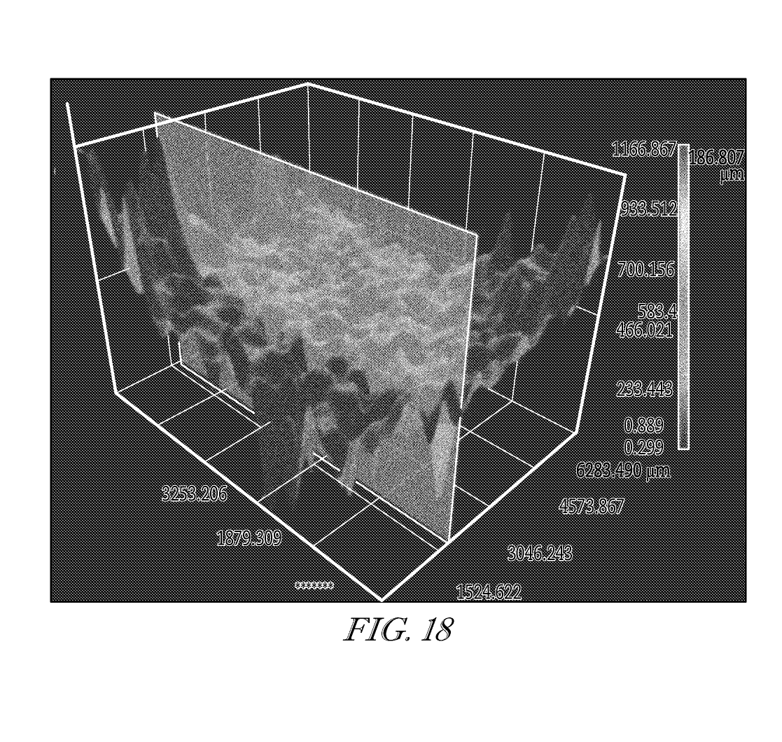

FIG. 18 shows the measurement results obtained by imaging the surface of the black plastic part. As shown in FIG. 18, the surface roughness is on the scale of about 50 μm to about 250 μm. The width of the peaks is about 500 μm to about 1200 μm, and the peak distribution is random with peak overlap.

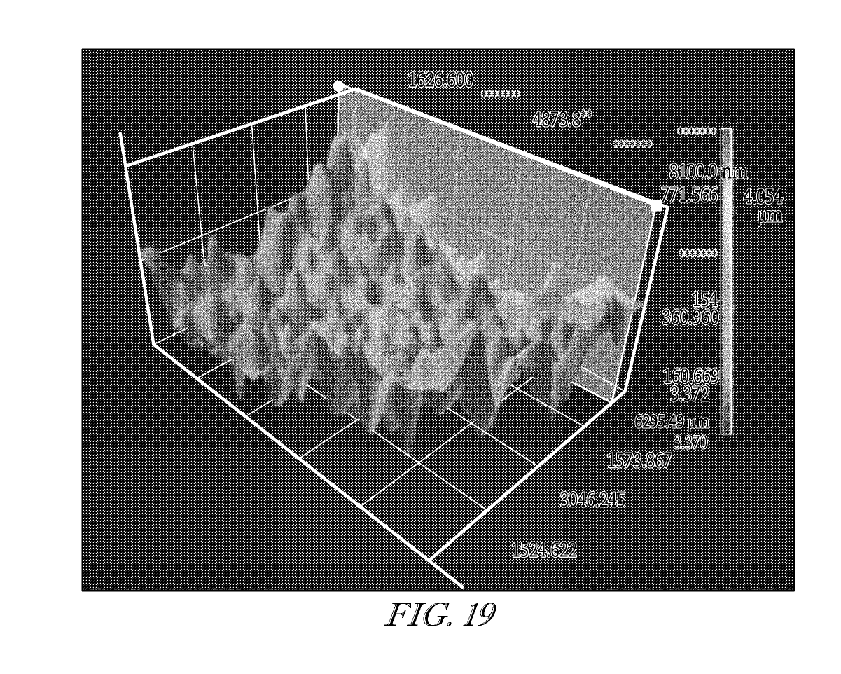

FIG. 19 shows the measurement results obtained by imaging the surface of the white plastic part. As shown in FIG. 19, the surface roughness is on the scale of about 40 μm to about 200 μm. The width of the peaks is about 350 μm to about 800 μm, and the peak distribution is random with a more separated structure as compared to that of the black plastic part. In addition, the white sample peaks have a pointy-top shape as compared to the more rounded top of the black plastic part.

In summary, non-contact optical topography was performed using a HIROX® digital microscope in topography mode on black and white plastic part surfaces excised from corresponding test lids. The black and white part surface were too rough (e.g., out of range) to be analyzed via AFM or ZEGAGE® optical profilometry. However, a HIROX® digital microscope in topography mode may be used to characterize surfaces having features ranging from micron to millimeter scale.

The HIROX® digital microscope in topography mode was used to image an 8 mm×8 mm area of the test lids, and surface roughness measurements were made on the convex (top) surface of the black and white plastic film parts. The measurement data are summarized in Table 9 below.

TABLE 9
Surface Roughness Measurement Results Obtained Using a Digital
Microscope in Topography Mode.

| | Peak-to-Valley (PV) | |
|---|---|---|
| Sample | Surface Roughness | Rₐ Surface Roughness |
| white-colored part | 227.9 μm (8 mm × 8 mm) | 42.9 μm (8 mm × 8 mm) |
| black-colored part | 195.2 μm (8 mm × 8 mm) | 52.6 μm (8 mm × 8 mm) |

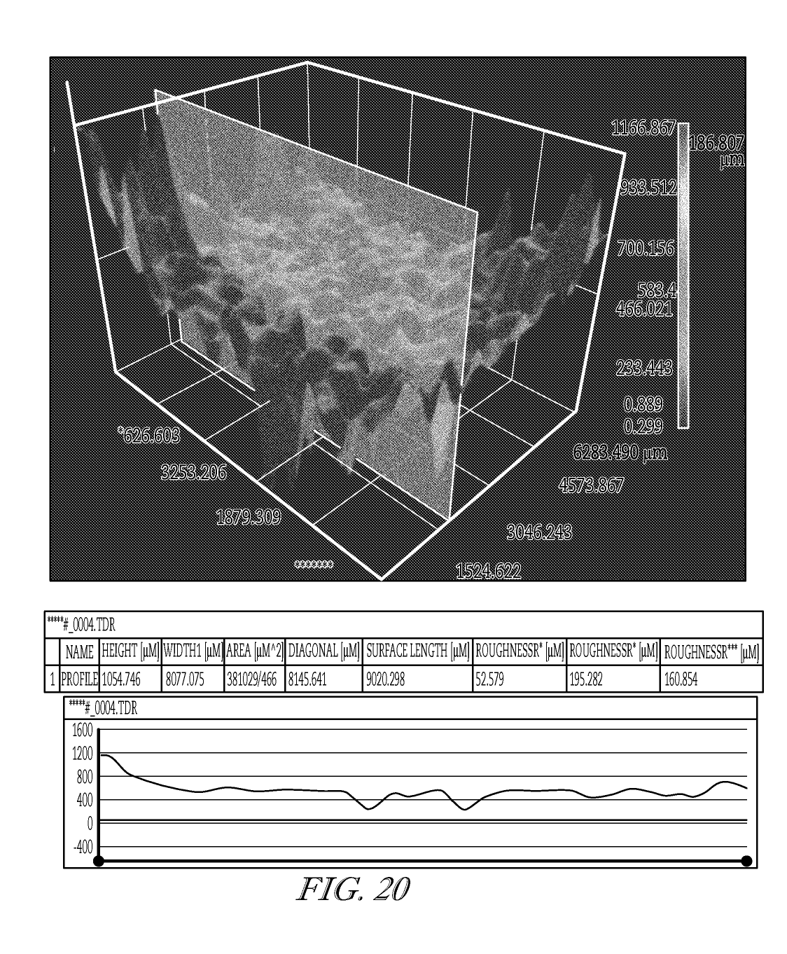

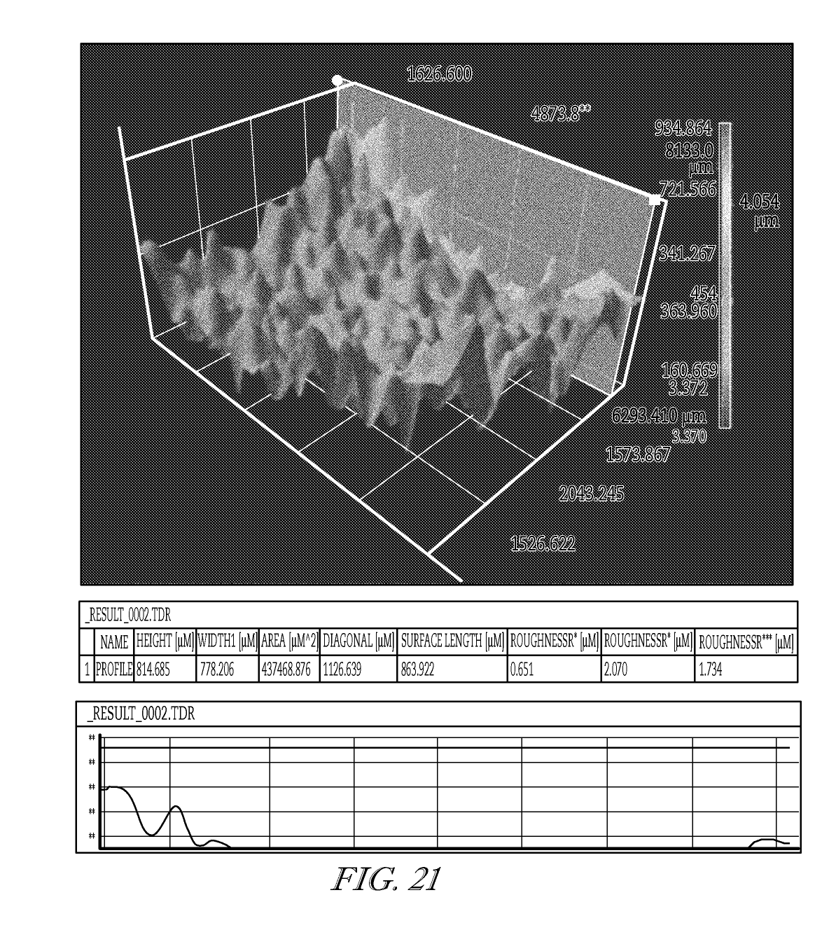

FIG. 20 shows a three-dimensional machine screen capture and corresponding 1D profile scan showing the measurement results obtained by imaging the surface of a black plastic part. FIG. 21 is a three-dimensional machine screen capture and corresponding 1D profile scan showing the measurement results obtained by imaging the surface of a white plastic part.

1. An insulative non-aromatic polymeric material, the insulative non-aromatic polymeric material comprising
a polymeric material and
a chemical blowing agent,
wherein the insulative non-aromatic polymeric material has a density in a range of about 0.5 g/cm³ to about 0.85 g/cm³ and a thermal conductivity in a range of about 0.05 W/(m*K) to about 0.3 W/(m*K).

2. The insulative non-aromatic polymeric material of claim 1, wherein a surface roughness of the insulative non-aromatic polymeric material is in a range of about 5 nm to about 365 nm and/or a surface roughness of the insulative non-aromatic polymeric material is in a range of about 1 μm to about 250 μm.

3. The insulative non-aromatic polymeric material of claim 2, wherein the insulative non-aromatic polymeric material has an Rₐ surface roughness of about 20 nm to about 50 nm as measured by optical profilometry on an image area of about 400 μm×400 μm, an Rₐ surface roughness of about 325 nm to about 350 nm as measured by optical profilometry on an image area of about 1.6 μm×1.6 μm, a PV surface roughness of about 155 nm to about 185 nm as measured by optical profilometry on an image area of about 400 μm×400 μm, and/or a PV surface roughness of about 1.60 μm to about 1.80 μm as measured by optical profilometry on an image area of about 1.6 μm×1.6 μm.

4. The insulative non-aromatic polymeric material of claim 3, wherein the insulative non-aromatic polymeric material has an Rₐ surface roughness of about 30 nm to about 40 nm as measured by optical profilometry on an image area of about 400 μm×400 μm, an Rₐ surface roughness of about 330 nm to 345 nm as measured by optical profilometry on an image area of about 1.6 μm×1.6 μm, a PV surface roughness of about 160 nm to 180 nm as measured by optical profilometry on an image area of about 400 μm×400 μm, and/or a PV surface roughness of about 1.65 μm to 1.75 μm as measured by optical profilometry on an image area of about 1.6 μm×1.6 μm.

5. The insulative non-aromatic polymeric material of claim 4, wherein the thermal conductivity is in a range of about 0.1 W/(m*K) to about 0.2 W/(m*K).

6. The insulative non-aromatic polymeric material of claim 5, wherein the polymeric material is a regrind polymeric material.

7. The insulative non-aromatic polymeric material of claim 6, wherein the regrind polymeric material is an insulative cellular non-aromatic polymeric material.

8. The insulative non-aromatic polymeric material of claim 6, wherein the regrind polymeric material is the insulative non-aromatic polymeric material.

9. The insulative non-aromatic polymeric material of claim 5, wherein the polymeric material is a homopolymer polypropylene.

10. The insulative non-aromatic polymeric material of claim 9, wherein the homopolymer polypropylene is highly crystalline.

11. The insulative non-aromatic polymeric material of claim 4, wherein the polymeric material includes a regrind polymeric material and a homopolymer polypropylene.

12. The insulative non-aromatic polymeric material of claim 2, wherein the insulative non-aromatic polymeric material has an Rₐ surface roughness of about 5 nm to about 25 nm as measured by atomic force microscopy on an image area of about 20 μm×20 and/or a PV surface roughness of about 70 nm to about 110 nm as measured by atomic force microscopy on an image area of about 20 μm×20 μm.

13. The insulative non-aromatic polymeric material of claim 12, wherein the insulative non-aromatic polymeric material has an Rₐ surface roughness of about 10 nm to about 20 nm as measured by atomic force microscopy on an image area of about 20 μm×20 and/or a PV surface roughness of about 80 nm to about 100 nm as measured by atomic force microscopy on an image area of about 20 μm×20 μm.

14. The insulative non-aromatic polymeric material of claim 2, wherein the insulative non-aromatic polymeric material has an Rₐ surface roughness of about 25 μm to about 65 μm as measured by a digital microscope in topography mode on an image area of about 8 mm×8 mm, and/or a PV surface roughness of about 160 μm to about 250 nm as measured by a digital microscope in topography mode on an image area of about 8 mm×8 mm.

15. The insulative non-aromatic polymeric material of claim 14, wherein the insulative non-aromatic polymeric material has an Rₐ surface roughness of about 35 μm to 60 μm as measured by a digital microscope in topography mode on an image area of about 8 mm×8 mm, and/or a PV surface roughness of about 175 μm to 235 μm as measured by a digital microscope in topography mode on an image area of about 8 mm×8 mm.

16. An insulative lid for a cup, the insulative lid comprising
a brim mount adapted to mount selectively to a brim included in a cup and
a central closure including a basin coupled to the brim mount to extend radially inward away from the brim mount and a drink spout coupled to the brim mount and the basin and arranged to extend upwardly away from the basin, the drink spout being formed to include a liquid-discharge outlet adapted to open into an interior liquid reservoir chamber formed in a cup,
wherein the insulative lid is made from an insulative non-aromatic material having a density in a range of about 0.5 g/cm³ to about 0.85 g/cm³.

17. The insulative lid of claim 16, wherein a surface roughness of the insulative non-aromatic polymeric material is in a range of about 5 nm to about 365 nm and/or wherein a surface roughness of the insulative non-aromatic polymeric material is in a range of about 1 μm to about 250 μm.

18. The insulative lid of claim 17, wherein the insulative non-aromatic polymeric material has an Rₐ surface roughness of about 20 nm to about 50 nm as measured by optical profilometry on an image area of about 400 μm×400 μm, an Rₐ surface roughness of about 325 nm to about 350 nm as measured by optical profilometry on an image area of about 1.6 μm×1.6 μm, a PV surface roughness of about 155 nm to about 185 nm as measured by optical profilometry on an image area of about 400 μm×400 μm, and/or a PV surface roughness of about 1.60 μm to about 1.80 μm as measured by optical profilometry on an image area of about 1.6 μm×1.6 μm.

19. The insulative lid of claim 18, wherein the insulative non-aromatic polymeric material has an Rₐ surface roughness of about 30 nm to about 40 nm as measured by optical profilometry on an image area of about 400 μm×400 μm, an Rₐ surface roughness of about 330 nm to 345 nm as measured by optical profilometry on an image area of about 1.6 μm×1.6 μm, a PV surface roughness of about 160 nm to 180 nm as measured by optical profilometry on an image area of about 400 μm×400 μm, and/or a PV surface roughness of about 1.65 μm to 1.75 μm as measured by optical profilometry on an image area of about 1.6 μm×1.6 μm.

20. The insulative lid of claim 19, wherein the insulative non-aromatic material has a thermal conductivity below about 0.2 W/(m*K).

21. The insulative lid of claim 20, wherein the insulative non-aromatic polymeric material has a thermal conductivity in a range of about 0.1 W/(m*K) to about 0.2 W/(m*K).
